(19) United States
(12) Patent Application Publication
(10) Pub. No.: US 2009/0217179 A1
(43) Pub. Date: Aug. 27, 2009

(54) SYSTEM AND METHOD FOR KNOWLEDGE NAVIGATION AND DISCOVERY UTILIZING A GRAPHICAL USER INTERFACE

(76) Inventors: Albert MONS, Rockville, MD (US); Nickolas Barris, Cherterfield, MO (US); Christine Chichester, Geneva (CH); Barend Mons, Moerkapelle (NL); Erik Van Mulligen, Rotterdam (NL); Marc Weeber, Groningen (NL)

Correspondence Address: Rahman LLC, 10025 Governor Warfield Parkway, Suite 110, Columbia, MD, 21044, US

(21) Appl. No.: 12/170,469

(22) Filed: Jul. 10, 2008

Related U.S. Application Data
(60) Provisional application No. 61/064,211, filed on Feb. 21, 2008.
(60) Provisional application No. 61/064,345, filed on Feb. 29, 2008.
(60) Provisional application No. 61/064,670, filed on Mar. 19, 2008.
(60) Provisional application No. 61/064,780, filed on Mar. 26, 2008.

(51) Int. Cl. G06F 3/048

(52) U.S. Cl. 715/760

(57) ABSTRACT

Methods and computer program products utilizing a graphical user interface for navigating concepts found in data produced by intellectuals in a knowledge discovery process are disclosed. The present invention utilizes a graphical user interface and related facilities for enabling community-based contributions in identifying associations between concepts disclosed by intellectuals. The present invention's approach results in having concepts mapped to authors and tools for linking related concepts with groups of intellectuals and/or contributors.

### CROSS-REFERENCE TO RELATED APPLICATIONS

This Application claims the benefit of, and is related to, the following of Applicants' co-pending applications:

U.S. Provisional Patent Application No. 61/064,211 titled “System and Method for Knowledge Navigation and Discovery” filed on Feb. 21, 2008;

U.S. Provisional Patent Application No. 61/064,345 titled “Enhanced System and Method for Knowledge Navigation and Discovery” filed on Feb. 29, 2008;

U.S. Provisional Patent Application No. 61/064,670 titled “Enhanced System and Method for Knowledge Navigation and Discovery” filed on Mar. 19, 2008;

U.S. Provisional Patent Application No. 61/064,780 titled “System and Method for Knowledge Navigation and Discovery Via Intellectual Networking” filed on Mar. 26, 2008;

U.S. Provisional Patent Application No. 60/909,072 titled “Method and Object for Knowledge Discovery” filed on Mar. 30, 2007;

U.S. Non-Provisional patent application Ser. No. 12/078,474 titled “System and Method for Wikifying Content for Knowledge Navigation and Discovery” filed Mar. 31, 2008; and

U.S. Non-Provisional patent application Ser. No. 12/078,473 titled “Data Structure, System and Method for Knowledge Navigation and Discovery” filed Mar. 31, 2008; each of which is incorporated by reference herein in its entirety.

### BACKGROUND OF THE INVENTION

1. Field of the Invention

The present invention generally relates to methods and computer program products for knowledge discovery and navigation utilizing a graphical user interface (GUI), and more particularly to methods and computer program products for displaying and navigating among the concepts found in the large amounts of data produced by intellectuals and/or other sources in order to facilitate the knowledge discovery process.

2. Related Art

In the current information era, information is being created at a phenomenal pace. For example, it has been estimated that the global, public Internet has over 500 billion pages of information spread out over 100 million Web sites and is growing every day. Such growth comes not only from Web site operators who “officially” post news stories, scientific research, Web logs (or “blogs”) and the like, but also from members of the public at large. That is, the Internet's vast amount of pages of data also grows as a result of various “Wiki”-type sites, which are typically collaborative Web sites that users can easily modify, usually without much restriction. (A wiki allows anyone, using a Web browser, to edit, delete or modify content that has been placed on the site, including the work of other authors.)

As information is being created at a phenomenal pace, with the Internet serving as just one convenient example of a data repository, locating and analyzing the relevant pieces of certain information has never been a more important yet labor-intensive task, relevant to all aspects of human society. Due to the fact that large amounts of information have been encoded in natural language text, finding the “golden nuggets” of relevant information in large collections of text is often dubbed “text mining.” Two main methodological approaches to text mining have developed over time—Information Retrieval (IR) and Information Extraction (IE).

### Information Retrieval: Finding Documents

The problem of information retrieval is as old as the origin of libraries and archives. Once books or other media containing information have been stored, they have to be found. Catalogs and indexes are common tools for accessing large collections. In the computer age, where many texts have been digitized, computational tools have been developed to index and retrieve documents from large collections. Users of these tools typically use “keywords” or sentences to query the database, and the classical result is a list of publications deemed relevant to the query. For example, the query “Find papers that discuss new treatments for lung cancer” will likely return references to papers describing recent clinical trials testing drugs for lung cancer.

Research and development in using computers for IR dates back to the 1950's. Various algorithms and applications have been developed, and scientific researchers use IR tools on a daily basis, due to the fact that many bibliographic and other information sources are available online. For example, searching the Web using Google or Yahoo! is a typical IR task. From a methodological point of view, three different approaches to IR can be distinguished: Boolean, probabilistic, and vector space search.

One of the most widely-used biomedical bibliographic databases is PubMed, which uses a Boolean model. The query above, for example, would be transformed to something like “lung cancer AND treatment.” While PubMed offers much refinement using keyword searching, it is still vulnerable to the typical disadvantages of Boolean searching: highly specific queries such as “papers AND discuss AND new treatments AND lung cancer” will typically yield results ranging from few to none. Furthermore, the results adhere to the word based and Boolean queries, and rank ordering the results based on relevance is typically not possible.

Both probabilistic and vector space searching offer a more sophisticated tool to deal with refined queries. For vector space retrieval, both the documents in a collection and the queries are represented by a vector of the most important words (i.e., keywords) in the text. For instance, the vector {papers, discuss, new treatments, lung cancer} represents the query above. Numeric values representing importance are assigned. After the documents and query have been transformed into a vector, angles between query and document vectors are typically computed. The smaller the angle between two vectors, the more similar these vectors are, or, in other words, the more similar or associated a document is to the query. The result of a vector space query is a list of documents that are similar in vector space. The first major improvement over Boolean systems is that the results can be rank-ordered. Thus, the first result is typically more relevant to the query than the last. The second major improvement is that even if not all words from the query are in any one document, in most cases the system will still return relevant results. Generally, the more refined and extensive a query is, the more refined the results are.

### Information Extraction: Finding Facts

While an IR query results in a list of publications that are potentially relevant to a user's query, the user still has to read through the resulting papers to extract the relevant information. Returning to the sample query above, for example, a user may not be interested in simply seeing a list of papers describing new treatments for lung cancer, but might prefer an actual list of these new treatments. Thus, considerable effort has been put into the discipline of IE.

One of the central approaches to IE has been to predefine a template of a certain fact or fact combination. For example, a biochemical reaction involves not only different reactants, but often also a mediator molecule (i.e., a catalyst). Further, such reactions are often localized to specific cells, and even to specific parts of a cell. Extraction algorithms would first search for the part in the text that mentions one or more of the reactants then attempt to fill in the template by, for example, interpreting the name of a cell type as the location of the reaction. In many cases, advanced Natural Language Processing (NLP) techniques are needed as it is important not to interchange the subject and the object. Also, semantic analysis to extract the actual meaning is needed. The sentence “Lung cancer patients taking cisplatinum showed some improvement” does imply that the drug cisplatinum is used for treating lung cancer. The knowledge that cisplatinum is a drug, and that lung cancer is a disease, would greatly facilitate the computation of the relation “cisplatinum treats lung cancer.” The computational efforts for this interpretation are much more demanding than for general IR, which explains why research and development in IE has only recently resulted in specialized systems that produce sufficiently accurate results.

### Beyond Mining: Discovery

While the explosion of digitally recorded information has daunting consequences for storage and retrieval, it also opens interesting avenues for knowledge discovery. Throughout human history, researchers have combined existing information with hunches to formulate hypotheses that are subsequently subject to testing. Human capacity to absorb information is limited, however, and computational tools to support hypothesis generation by processing large amounts of information comprise a promising tool in conducting research. Two main methodological approaches have been developed in this area, namely, relational discovery and associative discovery.

### Relational Discovery

Pioneering research by Professor Don Swanson resulted in novel scientific hypotheses that have been corroborated by experiments. See Swanson, D. R. “Undiscovered Public Knowledge,” Library Quarterly, 1986; 56:103-118, the entirety of which is incorporated by reference herein. Swanson's assumption is that if a scientific paper mentions a relationship between A and B, and another paper indicates a relationship between B and C, then hypothetically, A and C are related without the necessity of a factual record of this relationship. As current science is highly specialized and compartmentalized, the paper that states the A-B relationship could be unknown and irretrievable by a researcher specialized in C. Swanson's first discovery, for example, was that Eskimos have a fish-rich diet, and the intake of fatty acids in fish oils (A) is known to lower blood platelet aggregation and blood viscosity (B). Eskimos have therefore a lower incidence of different heart-related diseases. In an unrelated medical discipline studying Raynaud's disease (C), it was found that patients with this disease suffer from increased blood viscosity and above normal blood platelet aggregation (B). See Swanson D. R., “Fish Oil, Raynaud's Syndrome, and Undiscovered Public Knowledge,” Perspectives in Biology and Medicine, 1986; 30:7-18, the entirety of which is incorporated by reference herein. The transitive relationship that fish oil might improve the health of Raynaud's disease patients easily emerges, and was proven a few years after Swanson formulated the hypothesis by combining the information published in two unrelated scientific disciplines. In the past few years, different literature-based discovery tools have been developed that utilize the relational discovery principle. All of them to date, however, are in experimental stages, and not user-friendly.

### Associative Discovery

Another approach to hypothesizing novel relationships from existing data is to employ standard IR tools. The key issue here is that a transformation is needed from a document world to an “object” world. An object can be anything that represents a concept or real-world entity. For example, documents describing a certain disease may be combined or clustered into a format that is typical for that disease. The vector space model, for example, can easily accommodate this transformation. The vectors of the documents describing the disease can be combined into one vector representing the disease. In this way, collections of documents may be transformed into collections of diseases, drug, genes, proteins, etc. Using this approach, discovery comprises finding objects associated with the query object in the vector space. For example, if the query object is “lung cancer,” and the query is conducted on a collection of drug objects, the rank-ordered result of the query will contain not only drugs that have been mentioned together with lung cancer, but also drugs that have never been studied in this disease's context, which may be hypothetical new treatments for lung cancer. Similarly, a query using a vector representing Raynaud's disease in an object database storing chemicals and drugs will result in both existing treatments and potentially new treatments (such as fish oil). An important aspect of this “object” approach is that a search with any kind of object may be conducted, and any other kind of object may be requested.

### Researchers' Needs

The most common motivation of research scientists—just one class of users of vast data stores such as the Internet—is to understand why things work the way they work. Researches develop various experiments to replicate certain conditions and find out why things happen. Executing the experiment is very often another main motivation of a researcher.

The life cycle of a scientific project starts with the birth of an idea, which may be a well-defined hypothesis or just a hunch, by one or more scientists. The idea often follows from previous experimental outcomes that are combined with reported knowledge and novel hypotheses. The challenge of today's data and knowledge deluge is to optimally combine the widely varying sources of information and knowledge to select only the most promising hypotheses.

Further, researchers continuously scan the scientific radar for emerging information. Current electronic tools that automatically increase the pile of papers to be read should be replaced by tools that digest most of the information and only emit warning signals when truly interesting knowledge has just been or is about to be discovered.

Given the foregoing problems of large data stores and the limitations of conventional text mining, what are needed are methods and computer program products for knowledge navigation and discovery using a graphical user interface (GUI). Such methods and computer program products should allow vast data stores to be semantically searched, navigated, compressed and stored in order to facilitate relational, associative and/or other types of knowledge discovery.

### BRIEF DESCRIPTION OF THE INVENTION

Aspects of the present invention meet the above-identified needs by providing enhanced methods and computer program products for knowledge navigation and discovery, particularly within the context of a graphical user interface (GUI).

Based on concepts or units of thought rather than words, the methods and computer program products for facilitating knowledge navigation and discovery using a GUI are independent of choice of language and other concept representations. For a given field of study or endeavor, every concept in a thesaurus or ontology, or a collection thereof, is assigned a unique identifier. Two basic types of concepts are defined: (a) a source concept, corresponding to a query; and (b) a target concept, corresponding to a concept having some relationship with the source concept. Each concept, identified by its unique identifier, is assigned minimally three attributes: (1) factual; (2) co-occurrence; and (3) associative values. The source concept with all its associated (target) concepts that relate to the source concept with one or more of the attributes is stored in a novel data structure referred to as a “Knowlet™”. (As will be appreciated by those skilled in the relevant art(s), a data structure is a way of storing data in a computer so that it can be used efficiently. Often a carefully chosen data structure will allow the most efficient algorithm to be used. A well-designed data structure allows a variety of critical operations to be performed, using as few resources, both in terms of execution time and memory space, as possible. Data structures are implemented using data types, references and operations on them provided by a programming language.)

The factual attribute, F, is an indication of whether the concept has been mentioned in authoritative databases (i.e., databases or other repositories of data that have been deemed authoritative by the scientific community in a given area of science and/or other area of human endeavor). The factual attribute is not, in and of itself, an indication of the veracity or falsehood of the source and target concepts relationship.

The co-occurrence attribute, C, is an indication of whether the source concept has been mentioned together with the target concept in a unit of text (e.g., in the same sentence, in the same paragraph, in the same abstract, etc.) within a database or other data store or repository that have not been deemed authoritative. Again, the co-occurrence attribute is not, in and of itself, an indication of the veracity or falsehood of the concepts relationship.

The associative attribute, A, is an indication of conceptual overlap between the two concepts.

The Knowlet, with its three F, C, and A attributes represents a “concept cloud.” When an interrelation is created among the concept clouds of all identified concepts, a “concept space” is created. It should be noted that the Knowlets and their respective F, C, and A attributes are periodically updated (and may be changed), as databases and other repositories of data are populated with new information. The collection of Knowlets and their respective F, C, and A attributes are then stored in a knowledge database.

In one aspect of the present invention, the data structure, system, method and computer program product for knowledge navigation and discovery utilize an indexer to index a given source (e.g., textual) of knowledge using a thesaurus (also referred to as “highlighting on the fly”). A matching engine is then used to create the F, C, and A attributes for each Knowlet. A database stores the Knowlet space. The semantic associations between every pair of Knowlets/concepts are calculated based on the F, C, and A attributes for a given concept space. The Knowlet matrix and the semantic distances may be used for meta analysis of entire fields of knowledge, by showing possible associations between concepts that were previously unexplored.

An advantage of aspects of the present invention is that it can be provided as a research tool in the form of a Web-based or proprietary search engine, Internet browser plug-in, Wiki, or proxy server.

Another advantage of aspects of the present invention is that it allows users not only to make new (relational and associative) discoveries using concepts, but also allows such users to use a GUI to help conceptualize and visualize such discoveries.

Yet another advantage of aspects of the present invention is that redundancy from the World Wide Web, or any other data store, may be removed without losing unique information bits, thereby resulting in a compressed or “zipped” version of the Web that may be more easily stored, searched and shared.

Yet another advantage of aspects of the present invention is that it allows more complex (and thorough) Internet search queries to be automatically built during concept browsing than can ever be crafted by humans.

Yet another advantage of aspects of the present invention is that it allows public data stores and authoritative ontologies or thesauri, to be augmented by private data stores and ontologies or thesauri thereby allowing for a more complete concept space and thus more knowledge navigation and discovery capabilities.

Yet another advantage of aspects of the present invention is that it allows users to visually identify connections with experts related to particular concepts for collaborative research purposes.

Further features and advantages of aspects of the present invention, as well as the structure and operation of these various aspects of the present invention, are described in detail below with reference to the accompanying drawings and computer listing appendix.

### BRIEF DESCRIPTION OF THE FIGURES

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a system diagram of an exemplary environment, in which the present invention, in one aspect, may be implemented.

FIG. 2 is a block diagram of an exemplary computer system useful for implementing the present invention.

FIG. 3 is a flowchart depicting an exemplary GUI implementation of a knowledge and discovery process according to an aspect of the present invention.

FIG. 4 is a flowchart depicting a GUI implementation of exemplary Wikifier functions according to an aspect of the present invention.

FIG. 5 is a flowchart depicting an additional GUI implementation of exemplary Wikifier functions according to an aspect of the present invention.

FIGS. 6A-6B are flow charts depicting an exemplary GUI implementation of a knowledge and discovery process according to an aspect of the present invention.

FIGS. 7-9 are further flowcharts depicting additional GUI implementations of exemplary Wikifier functions according to an aspect of the present invention.

FIG. 10 is a flowchart depicting an exemplary concept aggregation and collection process according to an aspect of the present invention.

FIGS. 11A-11B flow charts depicting an exemplary process of text entries, tags and edits according to an exemplary aspect of the present invention.

FIG. 12 is a flowchart depicting an exemplary Knowlet space creation and navigation process according to an aspect of the present invention.

FIG. 13 shows a Web page depicting an exemplary graphical user interface implementation of a concept Web page portal according to an aspect of the present invention.

FIG. 14 shows a Web page depicting an exemplary graphical user interface implementation of an informational page for Wikifier according to an aspect of the present invention.

FIGS. 15-22 show exemplary Web pages accessible from the Wikifier informational page according to an aspect of the present invention.

FIGS. 23-28 show exemplary Web pages depicting the accessing of the Wikifier search functions according to an aspect of the present invention.

FIG. 29 shows a download page for the Wikifier plug-in according to an aspect of the present invention.

FIG. 30 shows a Web page depicting an exemplary informational page for the concept Web navigator according to an aspect of the present invention.

FIG. 31 shows a Web page depicting an exemplary dictionary lookup page according to an aspect of the present invention.

FIGS. 32-37 show Web pages depicting different aspects of an exemplary unified concept results page according to an aspect of the present invention.

FIGS. 38-46 show Web pages depicting different aspects of an exemplary concept page in a relational Wiki database according to an aspect of the present invention.

### DETAILED DESCRIPTION

### Overview

Aspects of the present invention are directed to methods and computer program products for knowledge navigation and discovery utilizing a GUI.

In one aspect of the present invention, an automated tool is provided to users, such as biomedical research scientists, to allow them to navigate, search and perform knowledge discovery within a vast data store, such as PubMed—one of the most-widely used biomedical bibliographic databases which is maintained and provided by the U.S. National Library of Medicine. PubMed includes over 17 million abstracts and citations of biomedical articles dating back to the 1950's. In such an aspect, the present invention does much more than simply allow biomedical researchers to perform Boolean searches using keywords to find relevant articles. Using a novel data structure, interchangeably referred to herein as a “Knowlet,” one aspect of the present invention allows scientists to make new relational, associative and/or other discoveries using concepts or units of thought (which would automatically include all synonyms of a concept expressed in a given language) from a data store and a relevant (e.g., biomedical) ontology or thesaurus, such as the United States National Library of Medicine's Unified Medical Language System® (UMLS) databases that contain information about biomedical and health related concepts.

Aspects of the present invention are now described in more detail herein in terms of the above exemplary biomedical researcher using the PubMed data store and a biomedical ontology. This description is provided for convenience only, and is not intended to limit the application of the present invention. After reading the description herein, it will be apparent to one skilled in the relevant art(s) how to implement the present invention in alternative aspects. For example, the present invention may be applied in any of the following areas, among others, where there is a vast data store, a relevant ontology/thesaurus, and a need for knowledge navigation and (relational, associative, and/or other) knowledge discovery:

The intelligence community may benefit from the present invention, in one aspect, by mining vast amounts of intercepted e-mails and/or other information, in different languages, suggesting suspicious Knowlets and associations, and mining for seemingly unrelated facts in large bodies of documents, for example.

The financial community may benefit from the present invention, in one aspect, by creating profiles of any document related to a financing deal structure, for example, including Knowlets of performance trends, management, and SEC filings, among others.

The legal community may benefit from the present invention, in one aspect, by profiling all cases and related rulings, and by creating the opportunity to not only find related documents, experts and rulings, but also to mine for potential relationships between concepts in large amounts of documents pertaining to one particular case (e.g., document production), for example.

The business community may benefit from the present invention, in one aspect, by mining a data store of owned patents and patent applications to find potential companies interested in licensing technologies similar to those disclosed therein, and by creating knowledge maps of companies involved in merger or acquisition activities, for example.

The health care community may benefit from the present invention, in one aspect, by relating patient databases with the scientific literature would allow patients to create online “patient Knowlets” and be alerted to new information relevant to a particular disease or new medications that become available for that disease; these patient Knowlets may also serve as a basis for studies performed on patients with rare diseases, for example.

The terms “user,” “end user”, “researcher”, “customer”, “expert”, “author”, “scientist”, “member of the public” and/or the plural form of these terms may be used interchangeably throughout herein to refer to those persons or entities capable of accessing, using, be affected by and/or benefiting from the tool that the present invention provides for knowledge navigation and discovery.

### The System

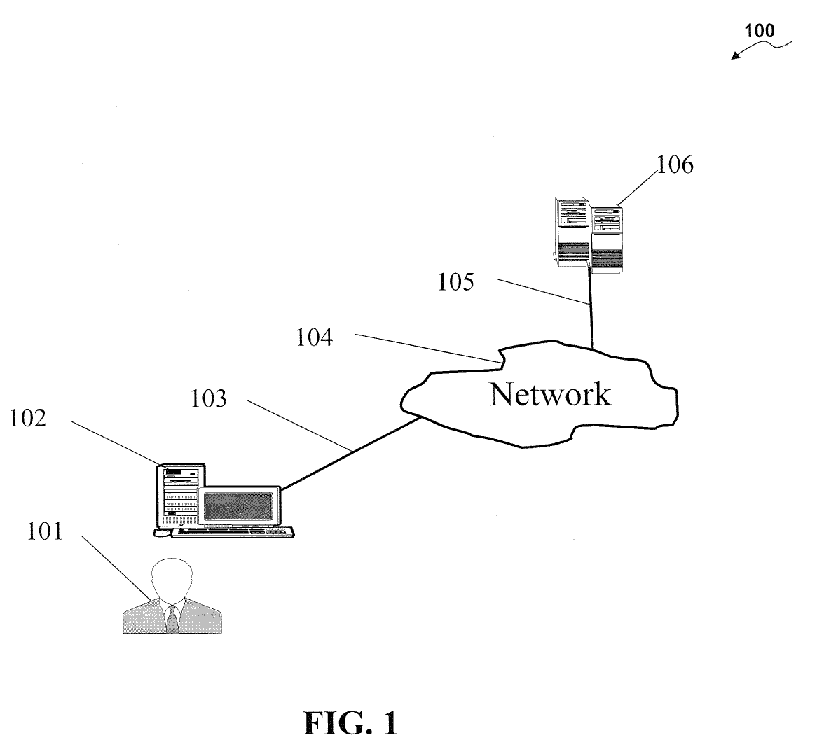

FIG. 1 presents an exemplary system diagram 100 of various hardware components and other features in accordance with an aspect of the present invention. As shown in FIG. 1, in an aspect of the present invention, data and other information and services for use in the system is, for example, input by a user 101 via a terminal 102, such as a personal computer (PC), minicomputer, laptop, palmtop, mainframe computer, microcomputer, telephone device, mobile device, personal digital assistant (PDA), or other device having a processor and input and display capability. The terminal 102 is coupled to a server 106, such as a PC, minicomputer, mainframe computer, microcomputer, or other device having a processor and a repository for data or connection to a repository for maintaining data, via a network 104, such as the Internet, via communication couplings 103 and 105.

As will be appreciated by those skilled in the relevant art(s) after reading the description herein, in such an aspect, a service provider may allow access, on a free registration, paid subscriber and/or pay-per-use basis, to the knowledge navigation and discovery tool via a World-Wide Web (WWW) site on the Internet 104. Thus, system 100 is scaleable such that multiple users, entities or organizations may subscribe and utilize it to allow their users 101 (ie., their scientists, researchers, authors and/or the public at large who wish to perform research) to search, submit queries, review results, and generally manipulate the databases and tools associated with system 100.

As will also be appreciated by those skilled in the relevant art(s) after reading the description herein, alternate aspects of the present invention may include providing the tool for knowledge navigation and discovery as a stand-alone system (e.g., installed on one PC) or as an enterprise system wherein all the components of system 100 are connected and communicate via a secure, inter-corporate, wide area network (WAN) or local area network (LAN), rather than as a Web service as shown in FIG. 1.

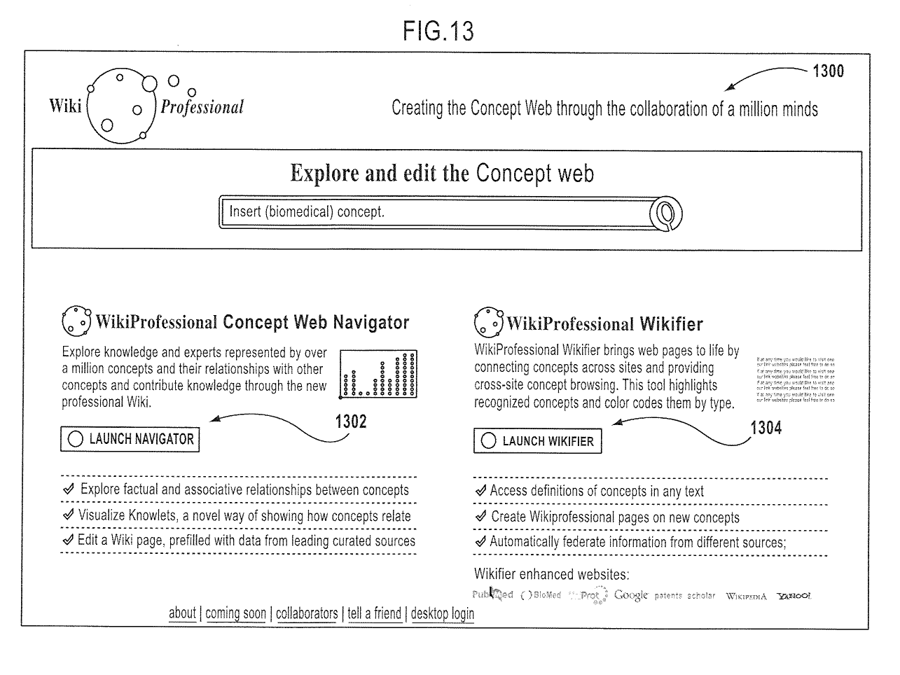

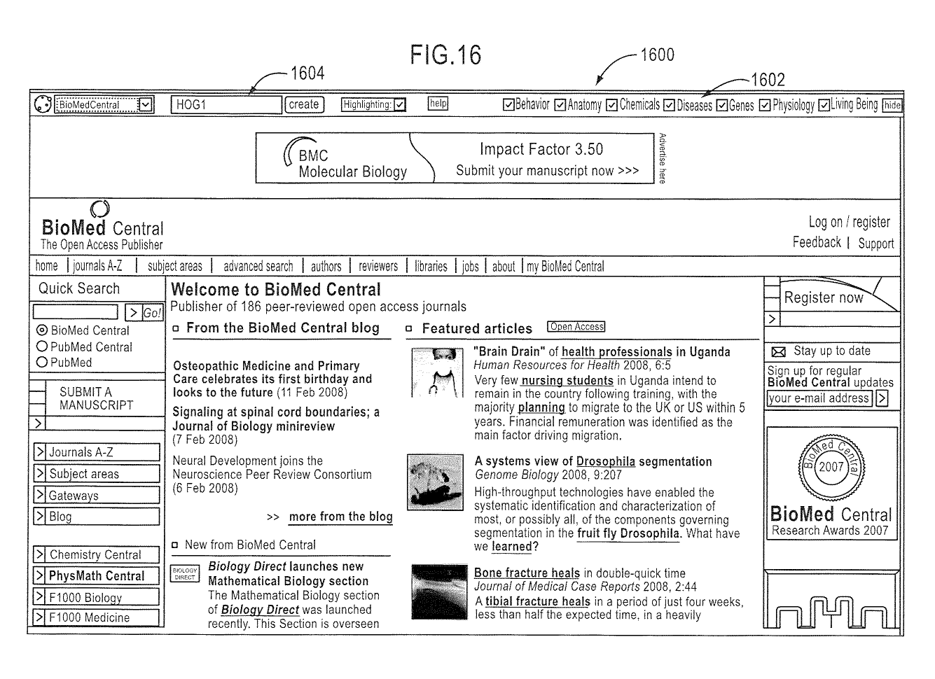

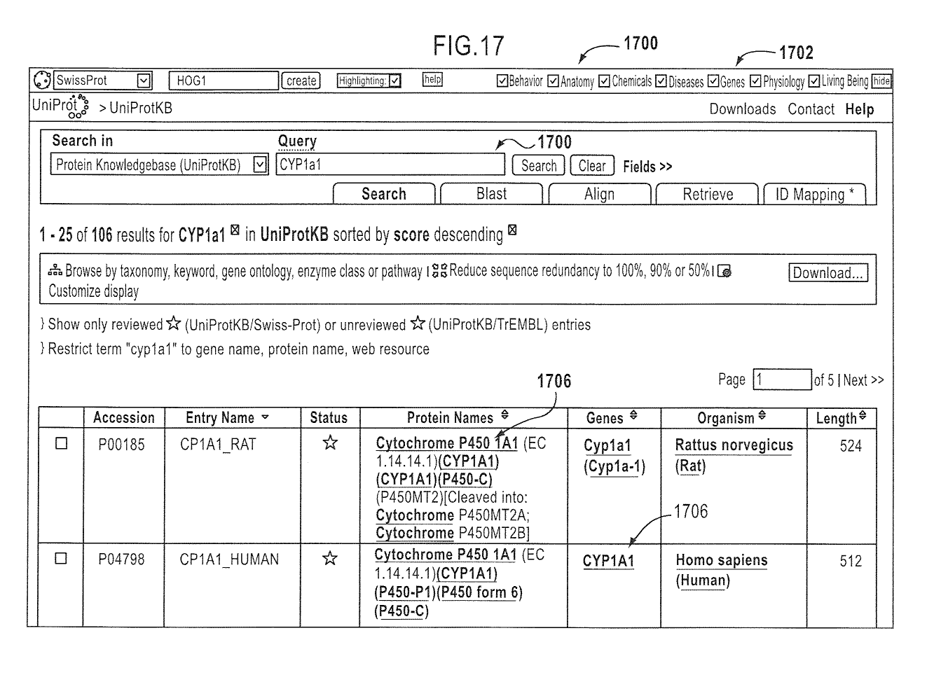

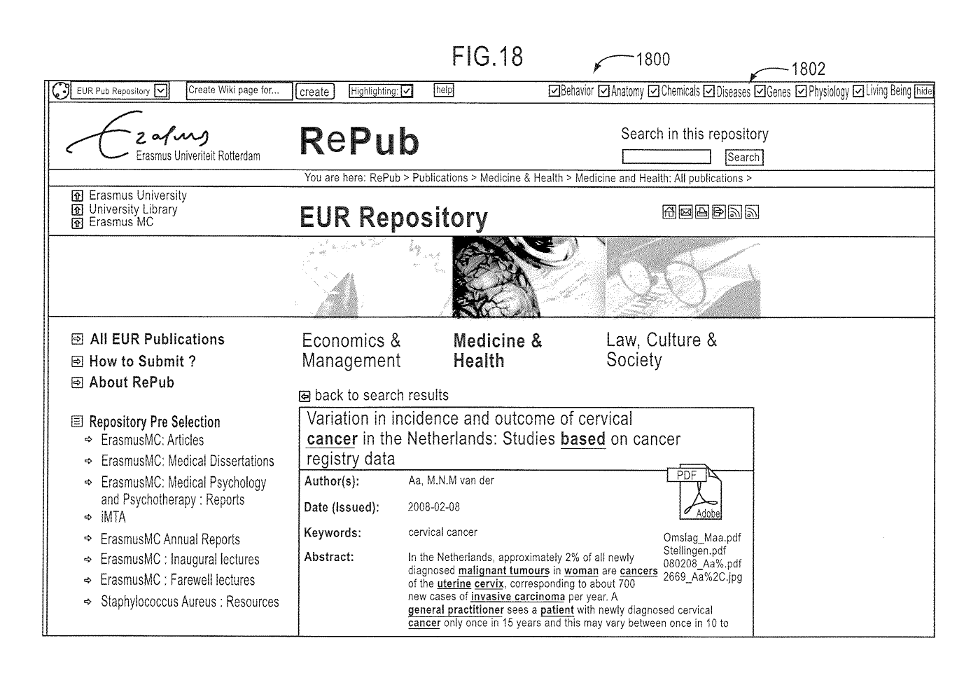

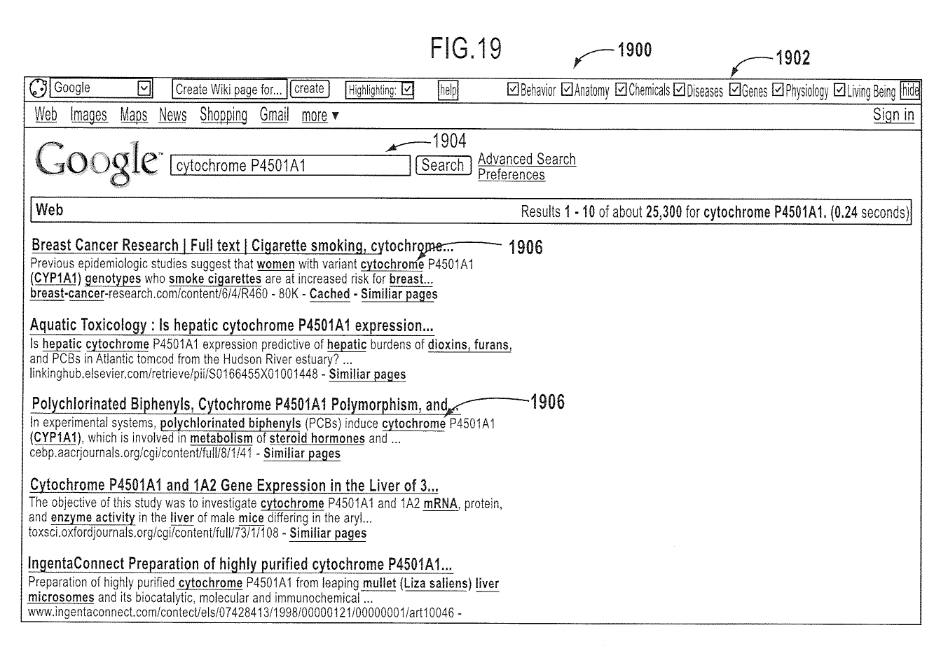

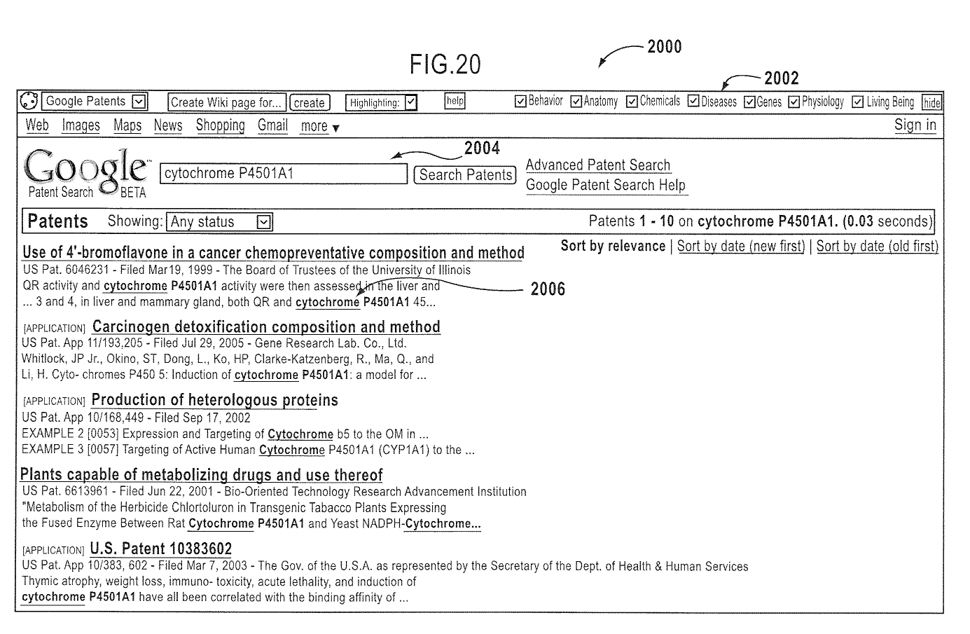

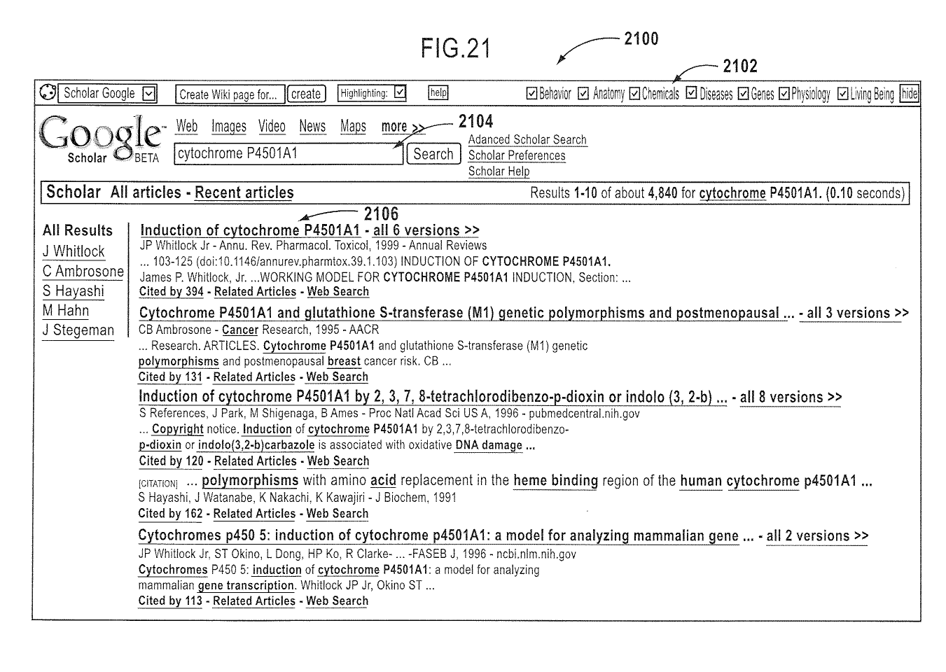

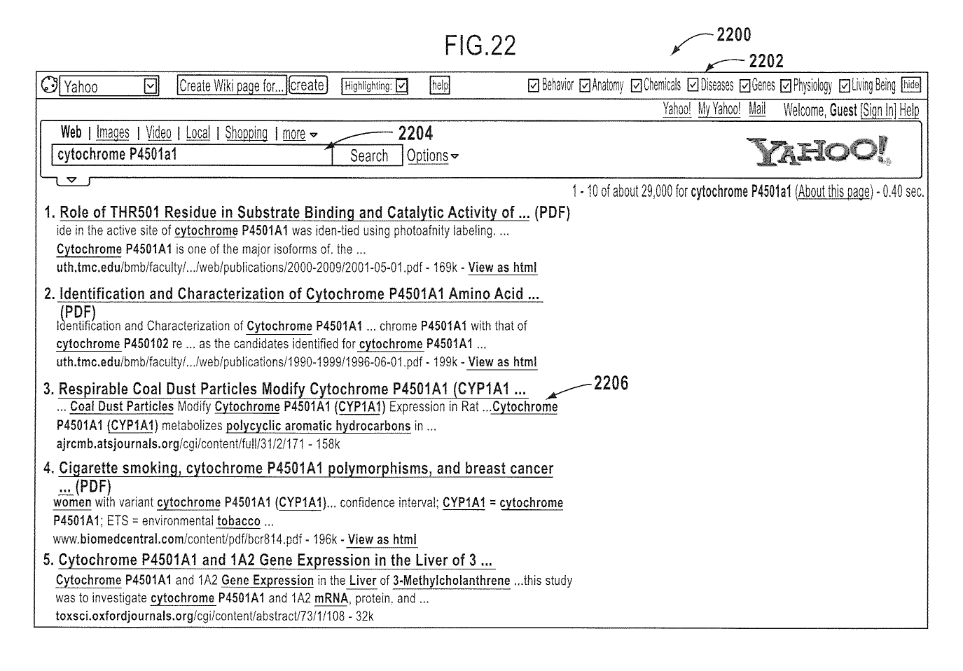

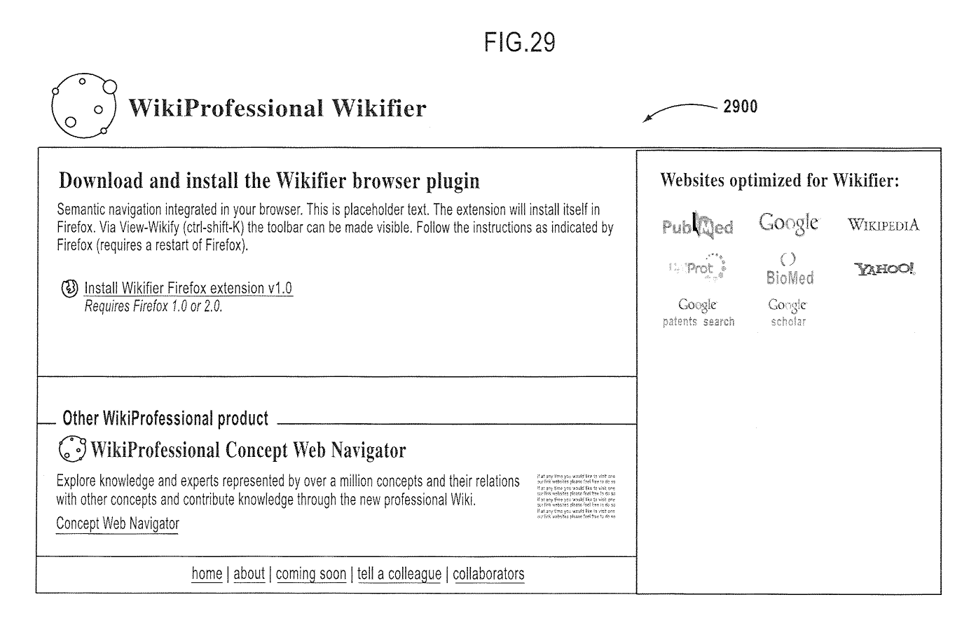

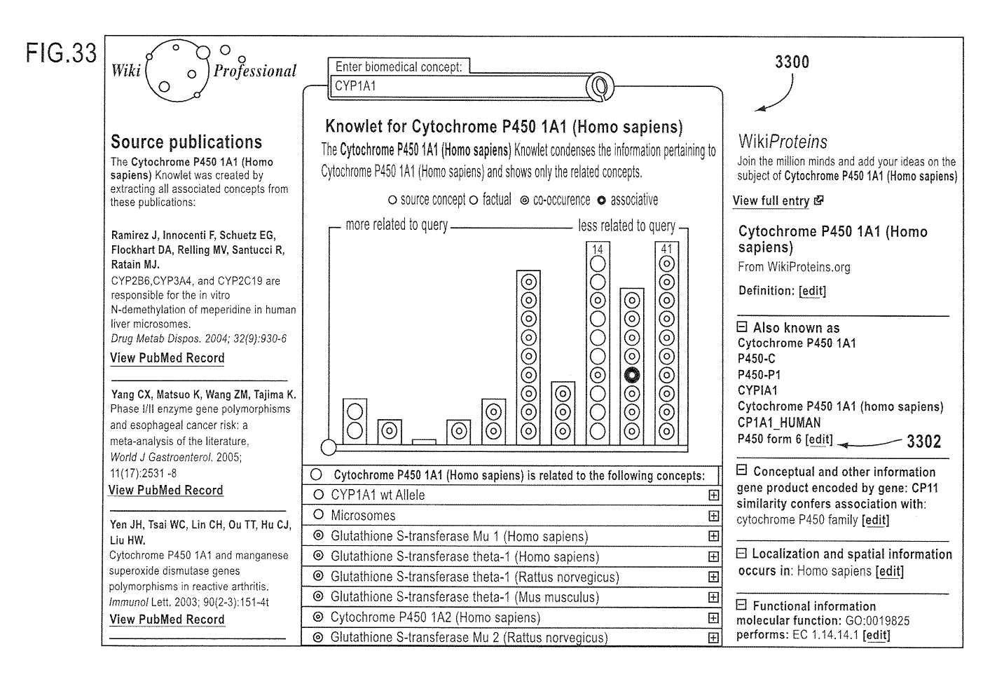

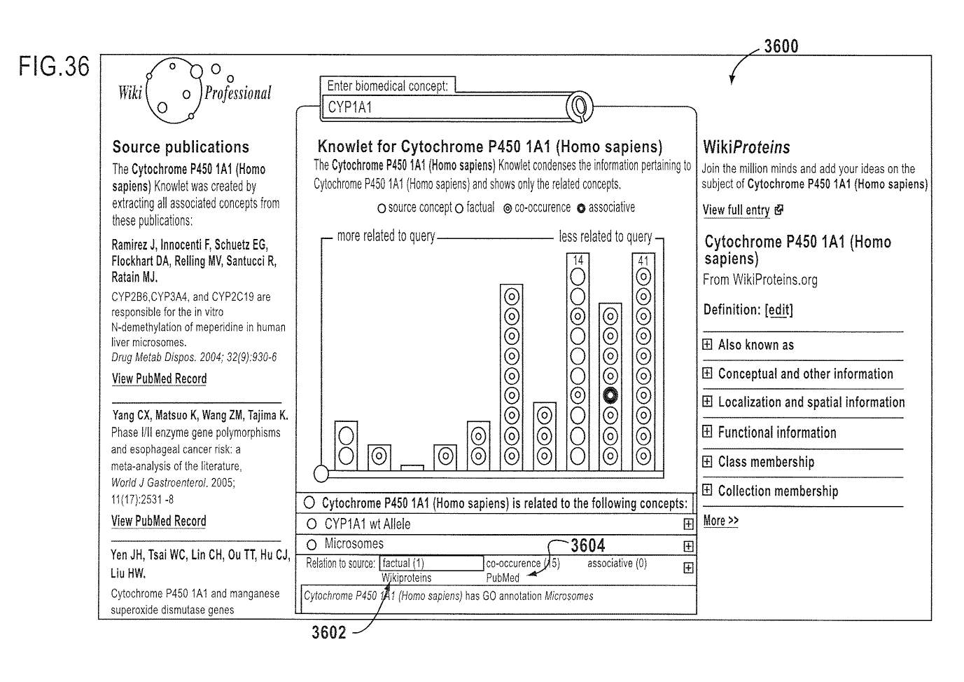

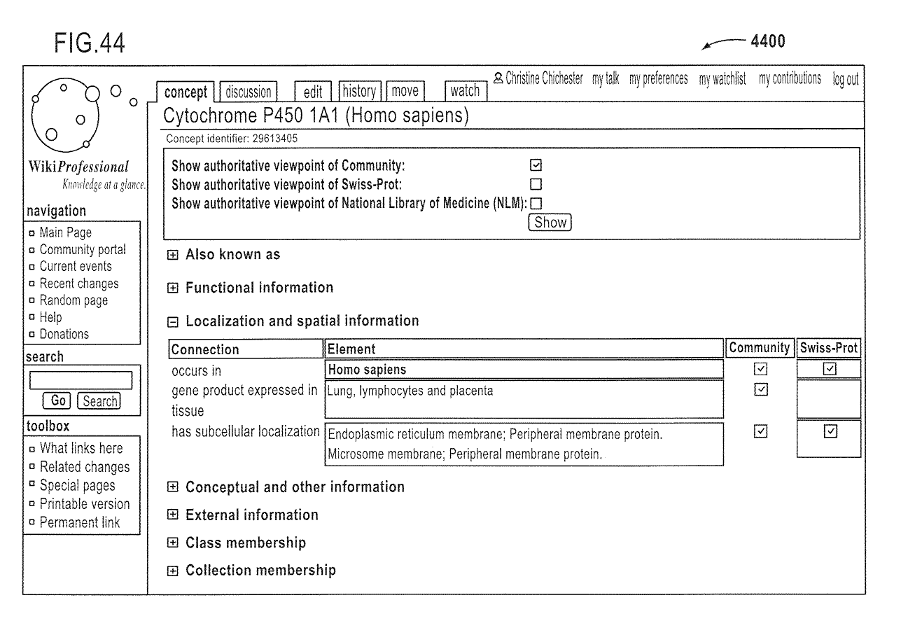

As will be appreciated by those skilled in the relevant art(s), in an aspect, graphical user interface (GUI) screens may be generated by server 106 in response to input from user 101 over the Internet 104. That is, in such an aspect, server 106 is a typical Web server running a server application at a Web site which sends out Web pages in response to Hypertext Transfer Protocol (HTTP) or Hypertext Transfer Protocol Secured (HTTPS) requests from remote browsers being used by users 101. Thus, server 106 (while performing any of the steps of the processes described below) is able to provide a GUI to users 101 of system 100 in the form of Web pages. These Web pages sent to the user's PC, laptop, mobile device, PDA or the like device 102, and would result in GUI screens (e.g., screens in FIGS. 13-46) being displayed.

### The Knowlet

In aspects of the present invention, a novel data element or structure called a “Knowlet” is employed to enable lightweight storage, precise information retrieval and extraction as well as relational, associative and/or other discovery. That is, each concept in a relevant ontology or thesaurus (in any discipline at any level of scientific detail) may be represented by a Knowlet such that it is a semantic representation of the concept, resulting from a combination of factual information extraction, co-occurrence based connections and associations (e.g., vector-based) in a concept space. The factual (F), the textual co-occurrence (C), as well as the associative (A) attributes or values between the concept in question and all other concepts in the relevant ontology or thesaurus, and with respect to one or more relevant data stores, are stored in the Knowlet for each individual concept.

In an aspect, the Knowlet can take the form of a Zope (an open-source, object-oriented Web application server written in the Python programming language distributed under the terms of the Zope Public License by the Zope Corp. of Fredericksburg, Va.) data element that stores all forms of relationships between a source concept and all its target concepts, including the values of the semantic associations to such target concepts).

Using such Knowlets, as will be described in more detail below, a “semantic distance” (or “semantic relationship”) value may be calculated for presentment to a user. The semantic distance is the distance or proximity between two concepts in a defined concept space, which can differ based on which data store or repository of data (i.e., collection of documents) used to create the concept space, but also based on the matching control logic used to define the matching between the two concepts, and the relative weight given to factual (F), co-occurrence (C) and associative (A) attributes. The goal of such an approach is to replicate key elements of the human brain's associative reasoning functionality. Just as humans use an association matrix of concepts “they know about” to read and understand a text, aspects of the present invention seek to apply this power of vast and diverse elements of human thought to data stores or repositories of data. Given the above, aspects of the present invention are able to “overlay” concepts within a given text with factual, co-occurrence and associative attributes, for example. It will be recognized by those of ordinary skill in the art, however, that any number of attributes may be used, as long as these attribute(s) represent a relationship that may link a given concept with another concept.

### The Methodology

In one aspect of the present invention, a search tool is provided to user 101 for knowledge navigation and discovery. In such an exemplary aspect, an automated tool is provided to users, such as biomedical research scientists, to allow them to navigate, search and perform knowledge discovery within a vast data store, such as PubMed.

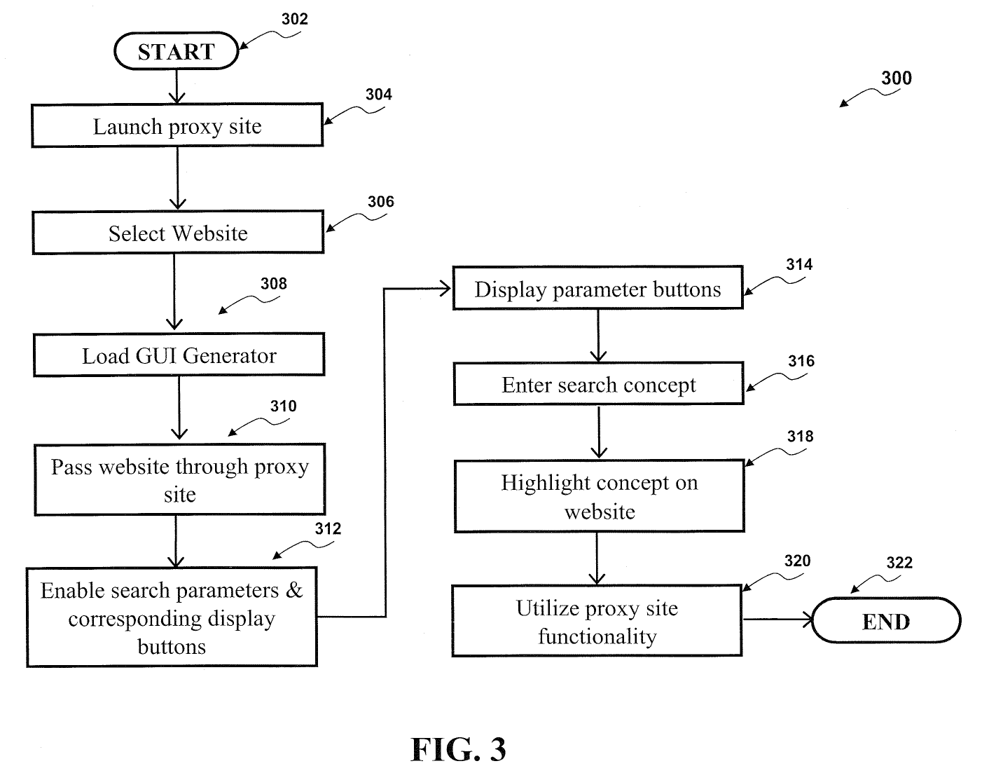

Referring to FIG. 3, a flowchart depicting an exemplary GUI implementation of a knowledge and discovery process 300 according to an aspect of the present invention is shown. In conjunction with process 300, reference is also made to FIGS. 13-28, which show, the GUI implementation of process 300 and, inter alia, a concept Web page portal, a GUI implementation of an informational page for Wikifier and exemplary Web pages accessible from the Wikifier informational page according to an aspect of the present invention.

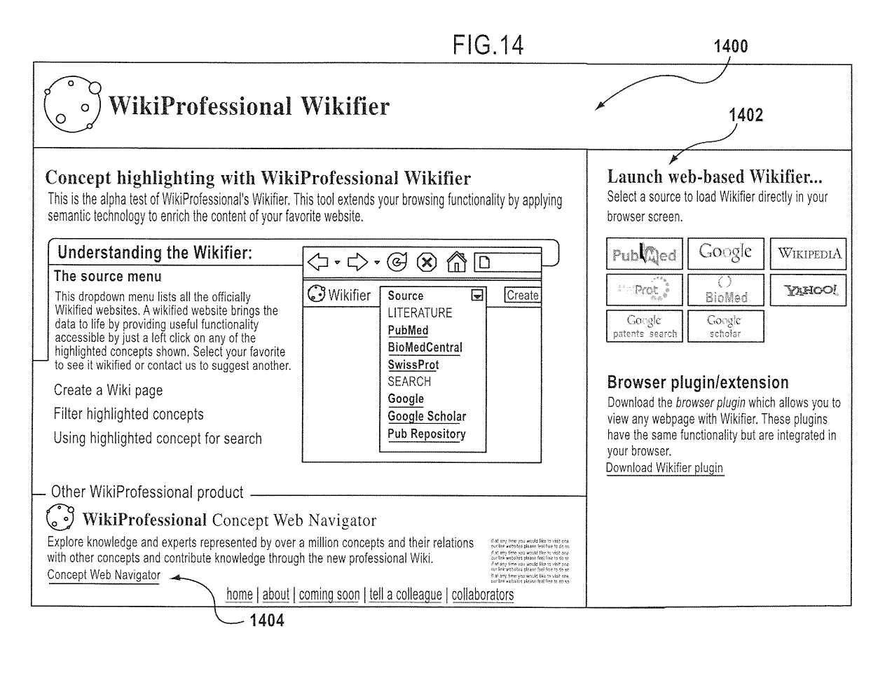

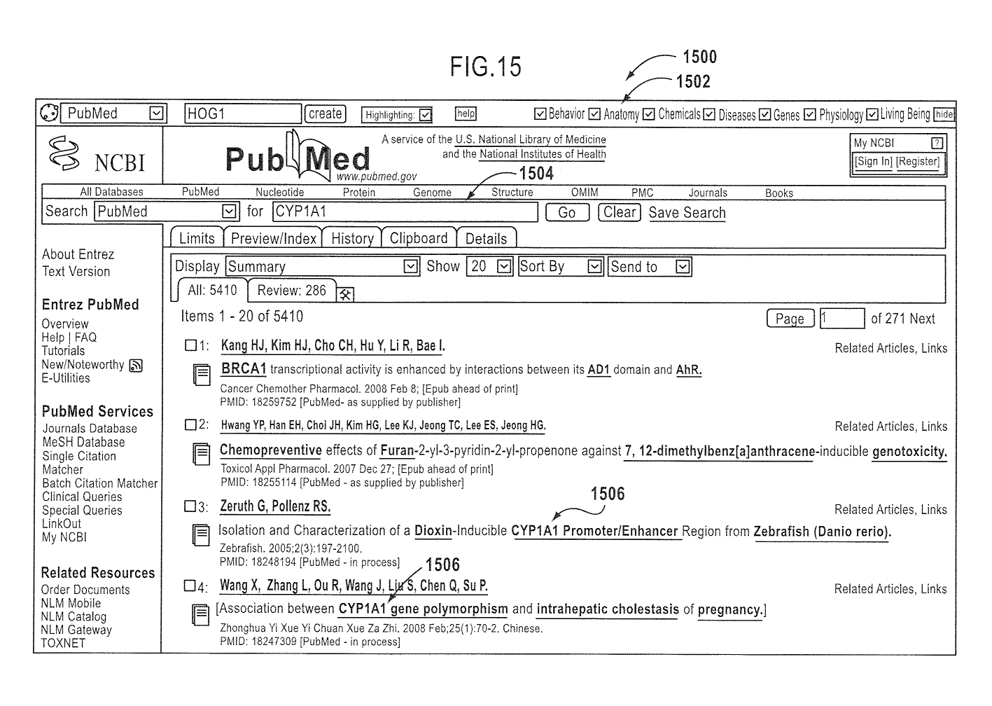

Process 300 begins at step 302 with control passing immediately to step 304. System 100, once prompted, launches, in step 304, the Wikifier proxy site shown as screen 1300 in FIG. 13. System 100 is prompted to launch the Wikifier proxy site once user 101 clicks on or selects launch button 1304. Alternatively, user 101 may navigate the concept database by clicking on the concept Web navigator button 1302. Once launched, system 100 displays screen 1400 as shown in FIG. 14. User 101, in step 306, then selects a Website from a panel 1402 for searching a concept. System 100 then loads the GUI generator and passes the selected Web site through the Wikifier proxy site in steps 310-312. System 100 also enables search parameters and their corresponding display buttons in steps 312-314. These search parameter buttons are shown as toolbar 1502, 1602, 1702, 1802, 1902, 2002, 2102 and 2202 of FIGS. 15-22 respectively, where FIGS. 15-22 show exemplary Web sites such as PubMed, BioMed Central, UniProtKB etc. User 101 then enters a search concept in step 316 using search box 1504, 1604, 1704, 1804, 1904, 2004, 2104 or 2204, depending on the respective Web site selected. Once selected, system 100 in step 318 highlights the concept on the selected or chosen Web site. The highlighted concepts are shown as 1506, 1706, 1906, 2006, 2106 and 2206 in FIGS. 15, 17 and 19-22, respectively. User 101, in step 320, is then able to utilize the proxy site functions, including, but not limited to, pop-up and search functions. Process 300 then terminates as indicated by step 322.

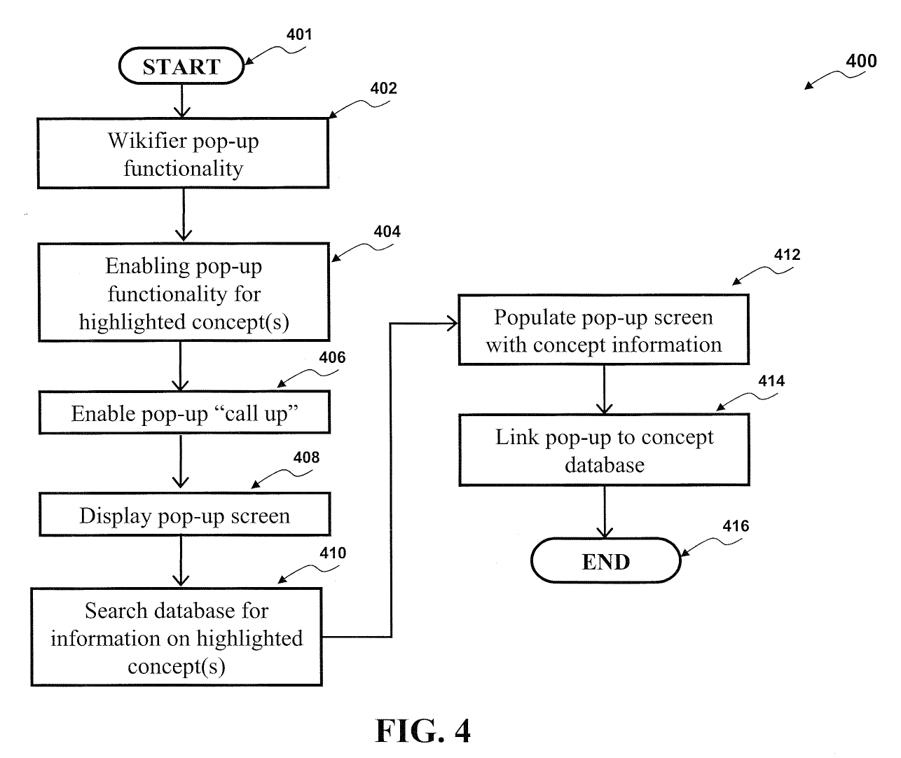

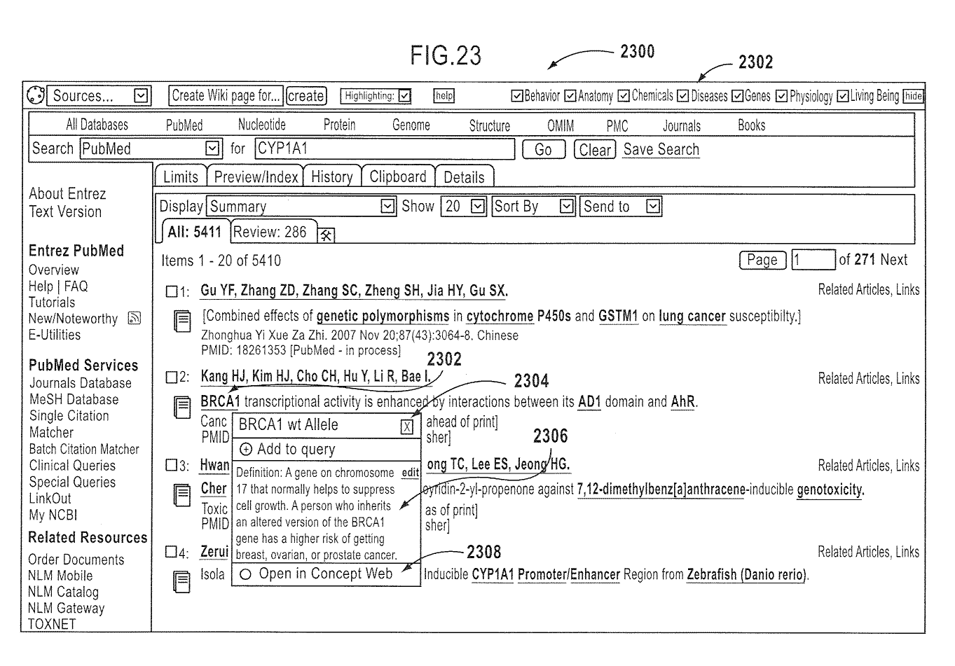

Referring now to FIG. 4, a flowchart depicting a GUI implementation of exemplary Wikifier functions according to an aspect of the present invention is shown. Here the Wikifier pop-up function process 400 is illustrated. In conjunction with process 400, reference is also made to FIG. 23 which depicts the GUI implementation of process 400, and also shows an exemplary Web page depicting the accessing of the Wikifier pop-up function according to an aspect of the present invention. Process 400 begins at step 401 with control passing immediately to step 402.

System 100 initializes the pop-up function in steps 402 and 404 once the concepts have been highlighted on the Web site (a task completed in step 318). System 100 then generates a pop-up function in step 406 by linking highlighted concept 2302 with pop-up screen 2304 displayed in step 408. System 100 then searches available databases for data on concept 2302 in step 410. In an aspect of the present invention, system 100 connects with to one or more data stores or databases (e.g., PubMed) containing the knowledge base in which the user seeks to navigate, search and discover. Thus, where the data store is one of biomedical abstracts, for example, the ontology may be one or more of the following ontologies, among others: the UMLS (as of 2006, the UMLS contained well over 1,300,000 concepts); the UniProtKB/Swiss-Prot Protein Knowledgebase, an annotated protein sequence database established in 1986; the IntAct, a freely available, open source database system for protein interaction data derived from literature curation or direct user submissions; the Gene Ontology (GO) Database, an ontology of gene products described in terms of their associated biological processes, cellular components and molecular functions in a species-independent manner; and the like.

Once the data is found, system 100 then populates pop-up screen 2304 in step 412 with the data from the data store or database. The data from the data store is shown in box 2306. System 100 in step 414 enables pop-up screen 2304 to be linked to the concept Web via link button 2308 at the bottom of pop-up screen 2304. Process 400 then terminates as indicated by step 416.

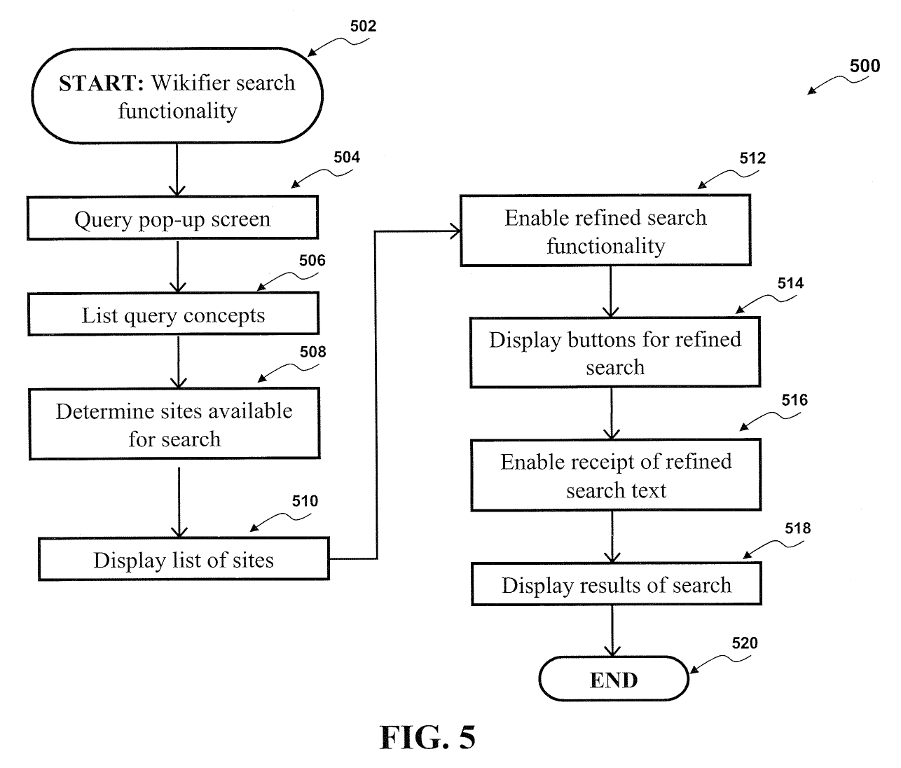

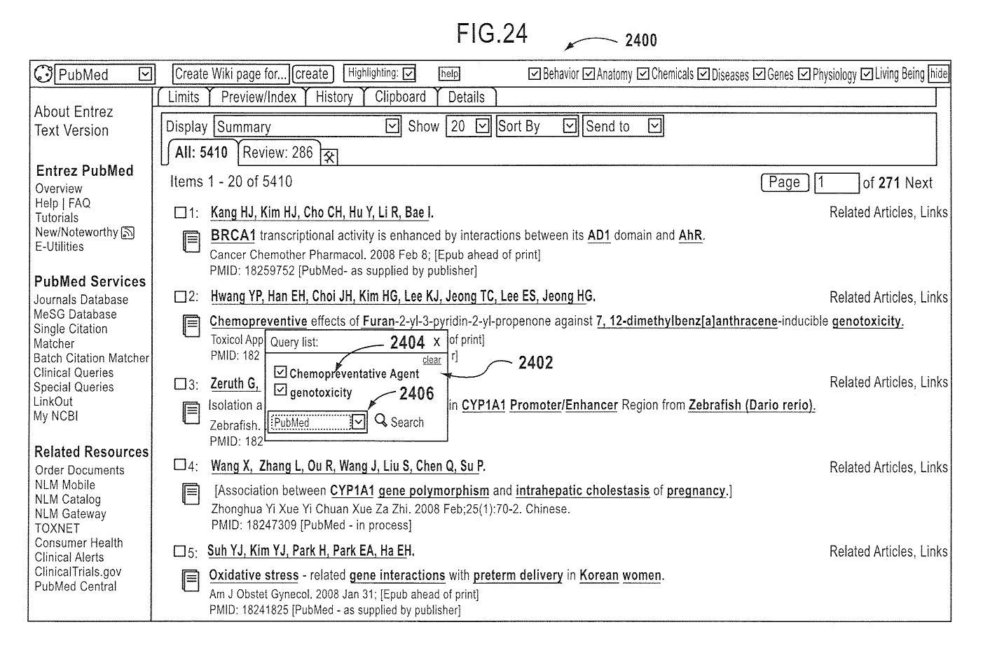

Referring now to FIG. 5, a flowchart depicting an additional GUI implementation of exemplary Wikifier functions according to an aspect of the present invention is shown. Here the Wikifier search query function process 500 is illustrated. In conjunction with process 500, reference is also made to FIGS. 24-26, which depict the GUI implementation of process 500 in addition to exemplary Web pages depicting the accessing of the Wikifier search query function according to an aspect of the present invention.

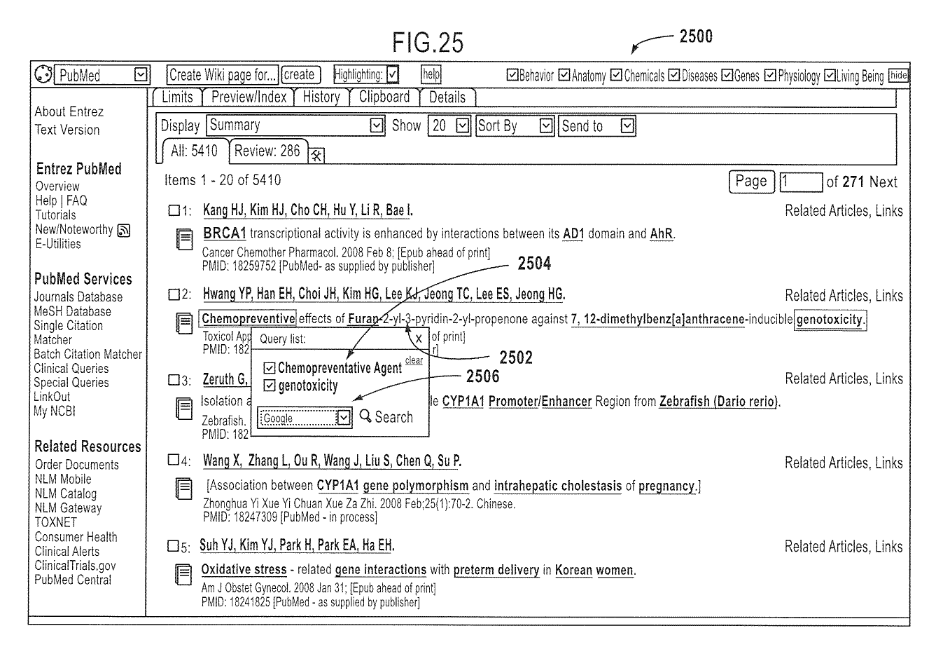

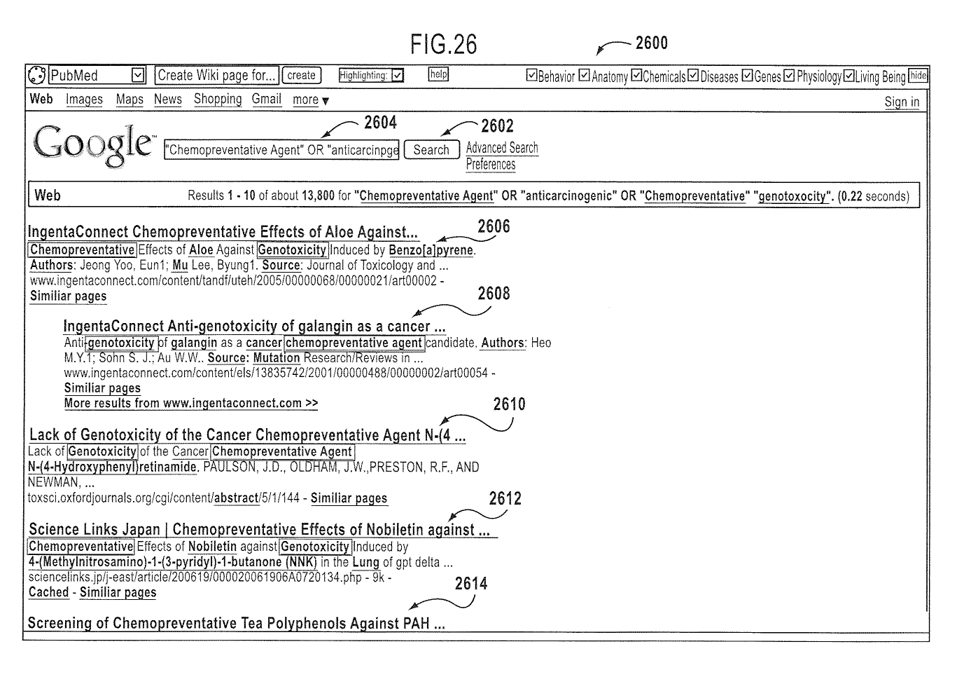

The Wikifier query functionality process 500 begins at step 502 with control passing immediately to step 504. System 100 in step 504 enables and displays query pop-up screen 2402 and 2502. A list of query concepts shown in FIGS. 24-25 as 2404 and 2504, respectively, is then displayed in step 506. System 100 then determines, in step 508, which Web sites are available for the query search using the list of query concepts. Pull down menu and button 2406 and 2506 list the available sites in step 510. Next, with “Google” selected as the search site, system 100, in step 512, enables a refined query search on the Google search results page shown as screen 2600 of FIG. 26. System 100 also enables and displays, in step 514, buttons 2602 for a refined search. System 100 further enables and displays, in step 516, the receipt of search terms or text via search term box 2604. Exemplary search results 2606-2614 are displayed in step 518. Process 500 then terminates as indicated by step 520.

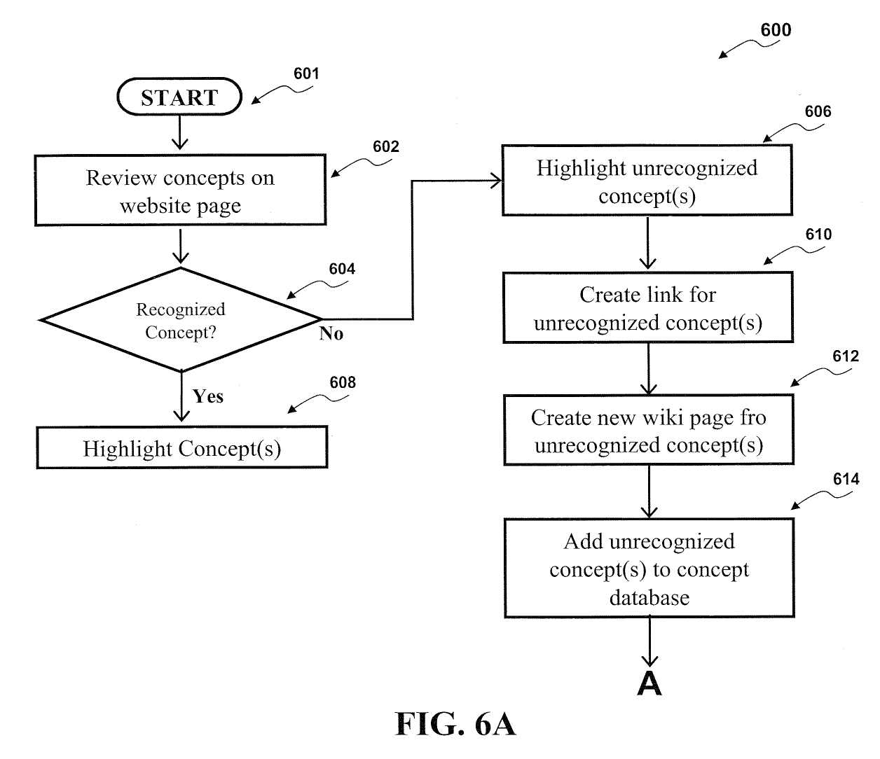

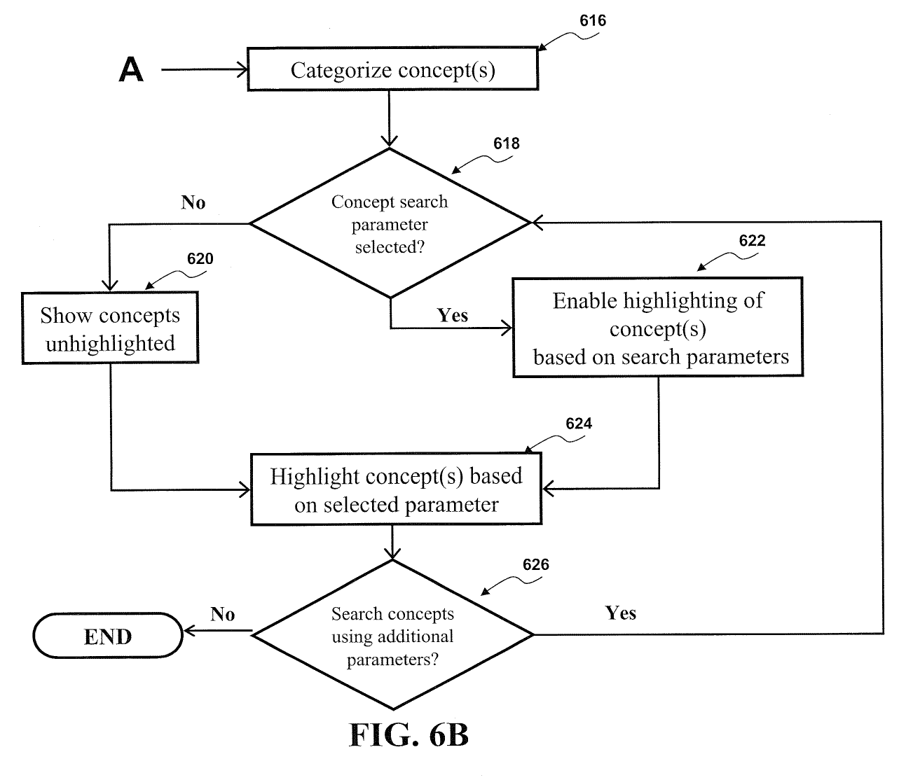

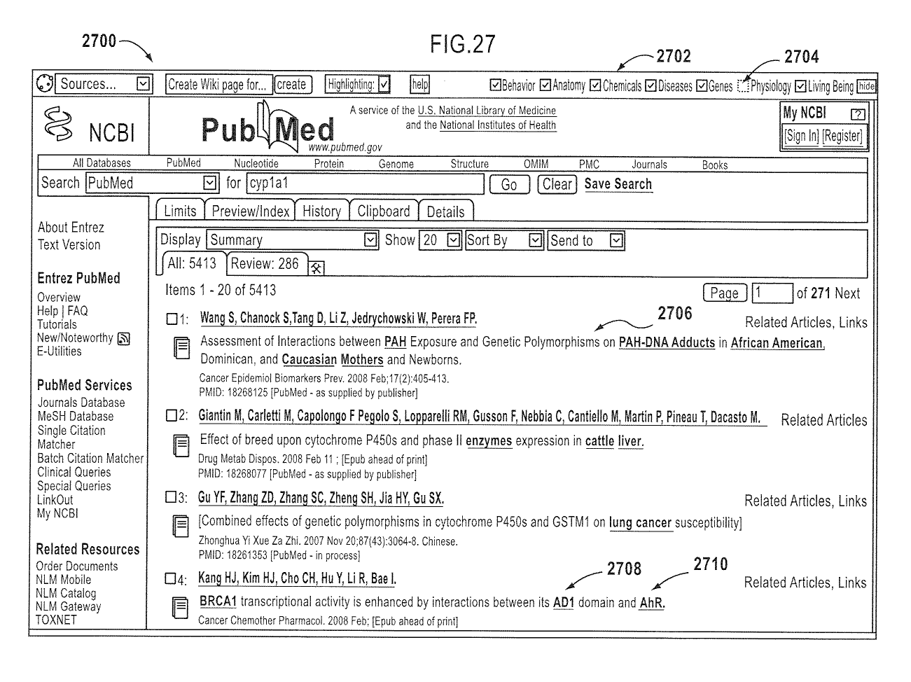

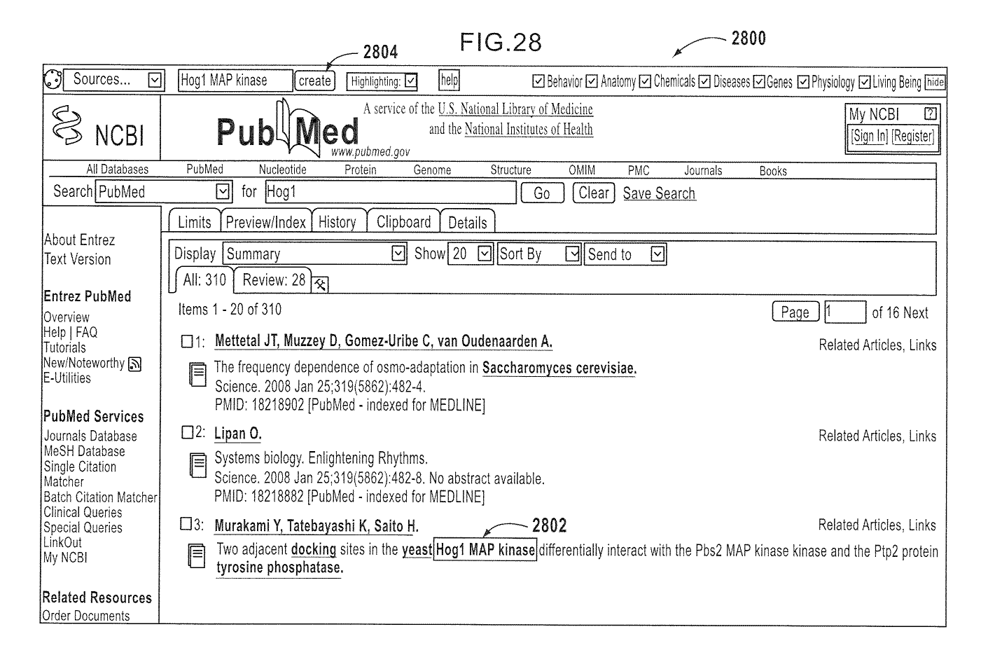

Referring now to FIGS. 6A-6B, flowcharts depicting an exemplary GUI implementation of a knowledge and discovery process 600 according to an aspect of the present invention is shown. In conjunction with process 600, reference is also made to FIGS. 27-28, which show exemplary Web pages depicting, inter alia, the GUI implementation of process 600 in addition to exemplary Web pages depicting the accessing of a Wikifier concept distinguishing function according to an aspect of the present invention.

Process 600 begins at step 601 with control passing immediately to step 602. In step 602, a review of the concepts on a Web site page by system 100 in step 602. System 100, in decision step 604, accesses the concept database to determine whether all concepts found on the page exist in the database. System 100 then highlights the recognized concepts. Where a concept is unrecognized, system 100, in step 606, highlights them in a different color. An exemplary highlighted and unrecognized concept is shown as 2802. System 100 then creates a link to a new wiki page for the unrecognized concept via link button 2804. The unrecognized concept is then added to the concept database in step 614. System 100, in step 616, then categorizes the concepts based on different parameters such as anatomy, physiology etc. as shown in parameter toolbar 2702 of FIG. 27. User 101 may then highlight the concepts on the page by selecting or turning on or off the parameter selection buttons shown on panel 2702. Where a parameter button is unchecked, the corresponding concept is not highlighted. As such, system 100 decides, in decision step 618, whether to highlight a concept based upon the parameters selected. Here, the “Physiology” button 2704 remains unchecked or not selected and as a result, concept 2706 (Polymorphisms) remains unhighlighted (step 620) whereas concepts 2708 and 2710 are highlighted in step 624 as these concepts fall under one of the remaining parameters on toolbar 2702 that are checked. Process 600 then terminates as indicated by step 628.

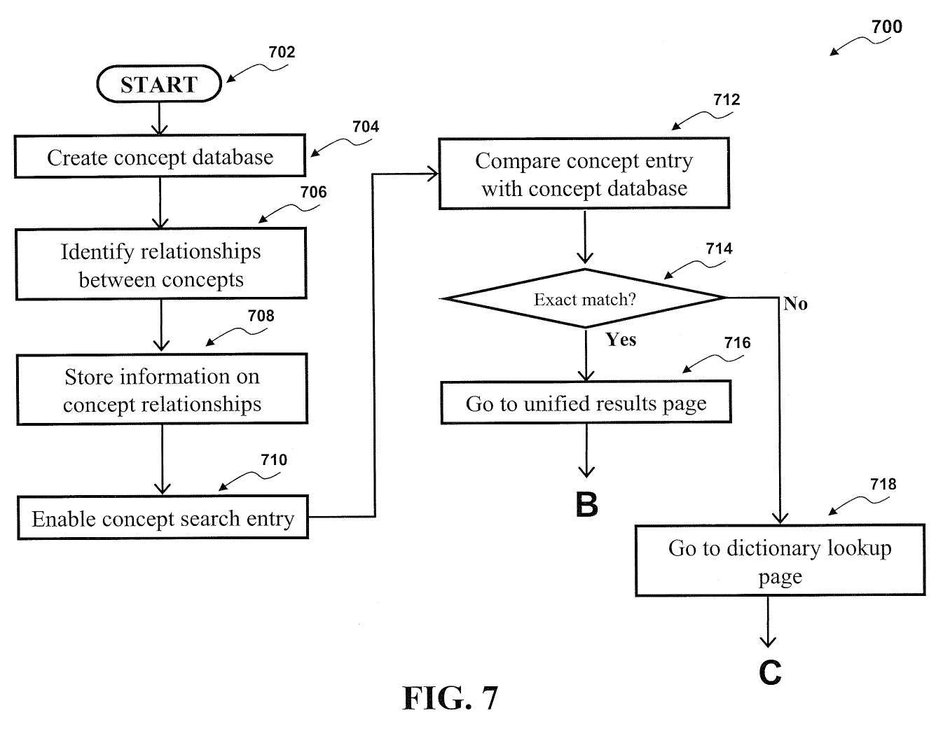

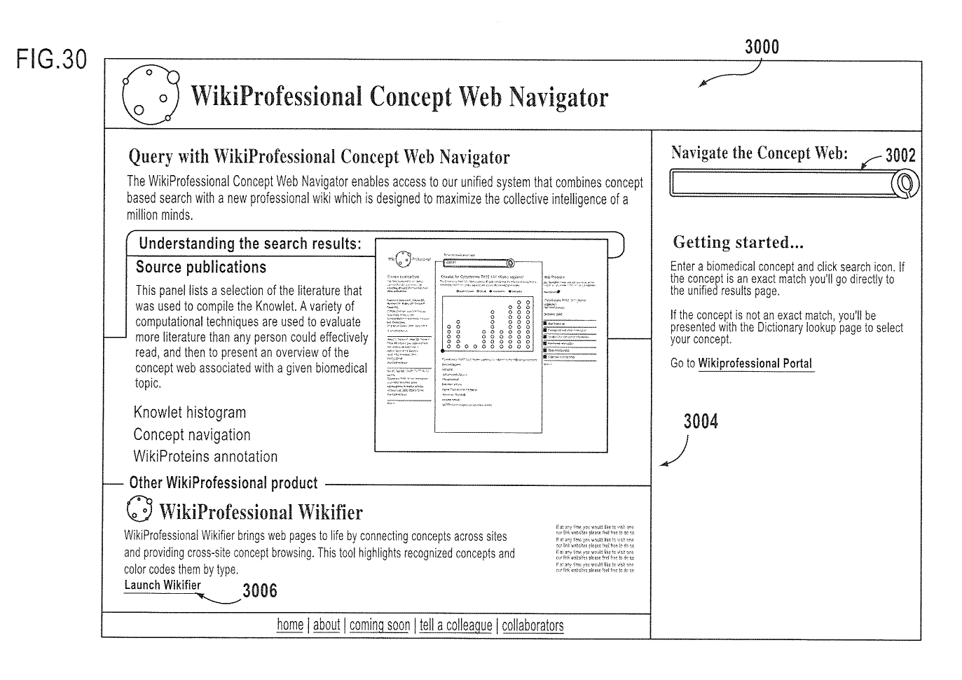

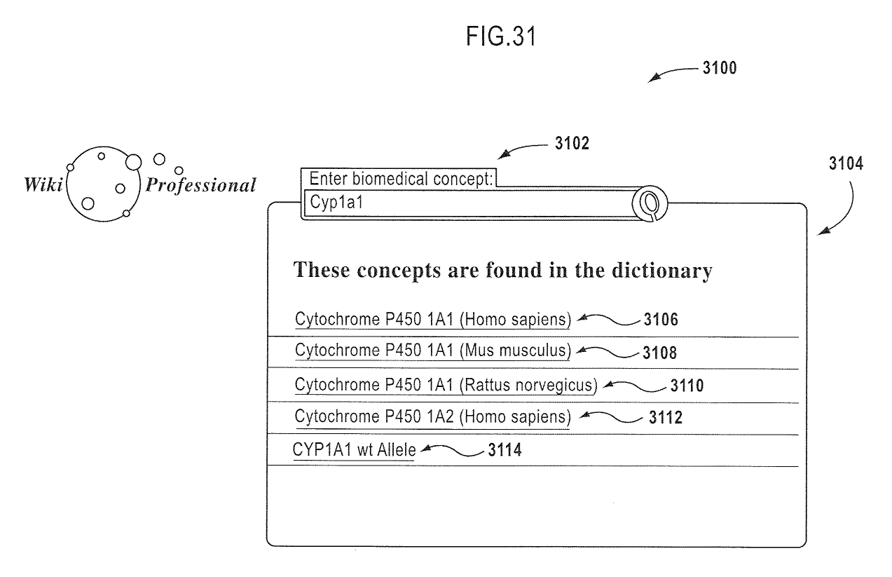

Referring now to FIG. 7, a flowchart depicting an exemplary GUI implementation of a knowledge and discovery process 700 according to an aspect of the present invention is shown. In conjunction with process 700, reference is also made to FIGS. 30-31, which show exemplary Web pages depicting, inter alia, the GUI implementation of process 700 and exemplary informational pages for the concept Web navigator and exemplary dictionary lookup pages according to an aspect of the present invention.

Process 700 begins at step 702 with control passing immediately to step 704. System 100 creates a concept database in step 704 where concepts, collected and developed data on concepts and concept relationships etc. are stored. System 100 identifies the relationships between concepts in step 706 and stores such relationships in step 708.

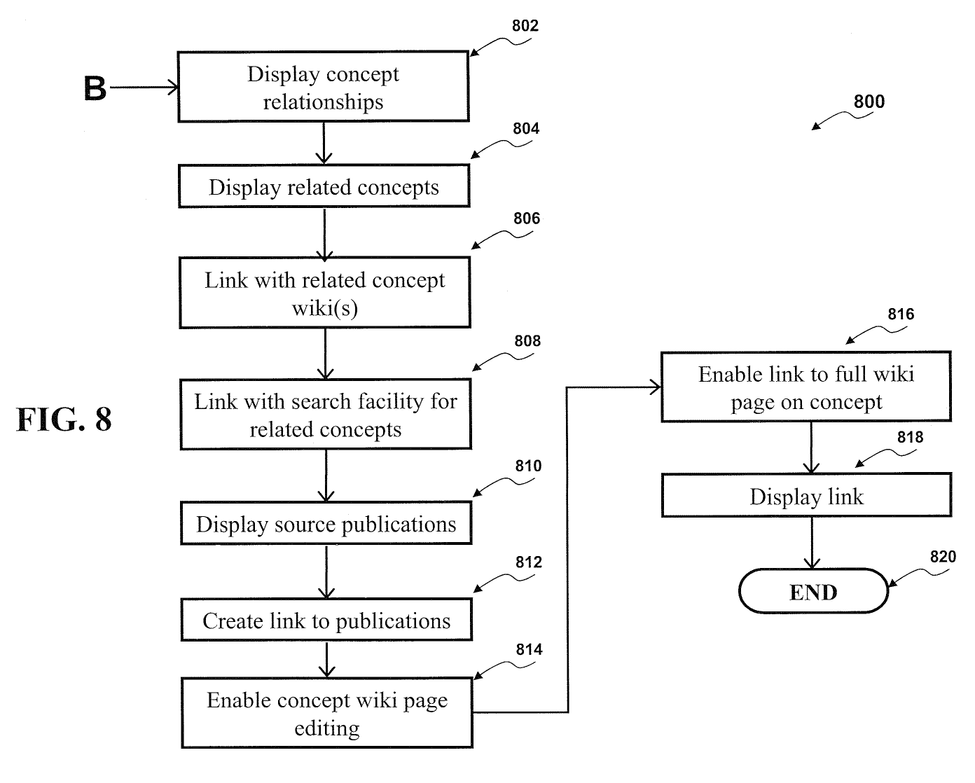

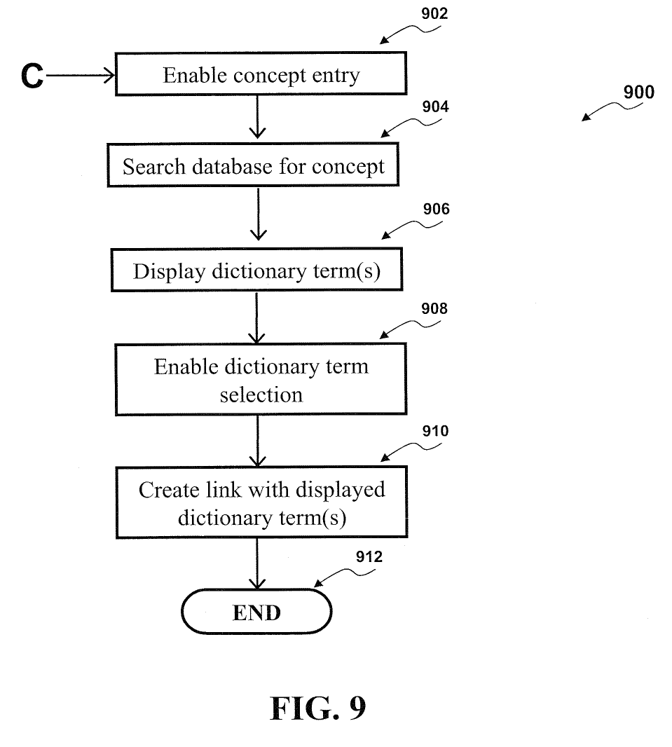

System 100 then enables a user to conduct a concept search in step 710. System 100 does so by generating search toolbar/box 3002 as shown in FIG. 30. System 100, in step 712, then compares the concept entry with data in the concept database. Once there is a match as determined in decision step 714, user 101 is directed to a unified results page in step 716 (discussed with reference to FIG. 8 below). If there is no match, user 101 is directed to a dictionary lookup page in step 718 (discussed with reference to FIG. 9 below).

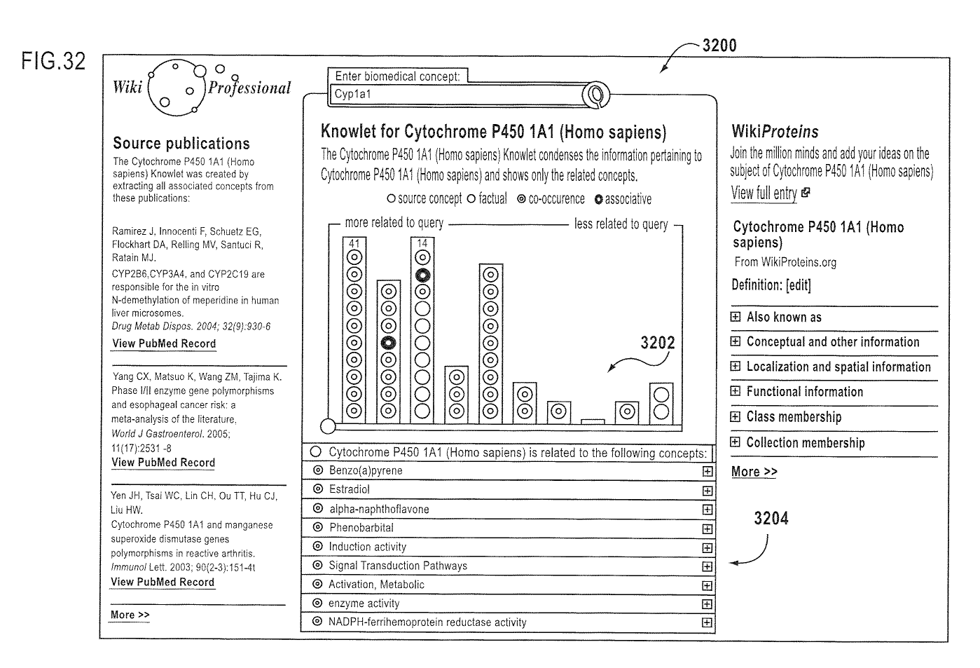

Referring now to FIG. 8, a flowchart depicting an exemplary GUI implementation of the unified results page process 800 according to an aspect of the present invention is shown. In conjunction with process 800, reference is also made to FIGS. 32-37, which show exemplary Web pages depicting, inter alia, the GUI implementation of process 800 and different aspects of an exemplary unified concept results page according to an aspect of the present invention.

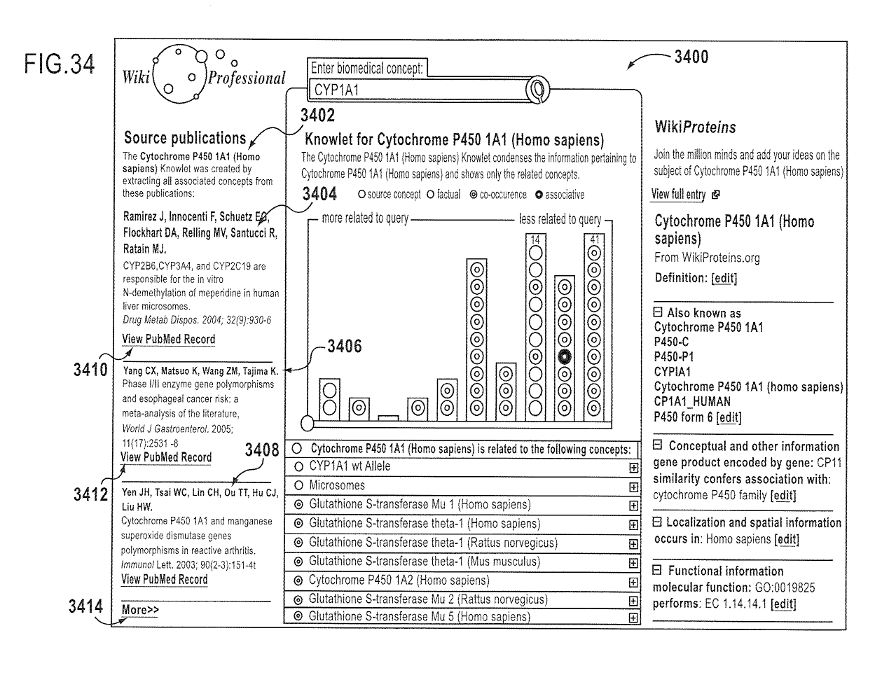

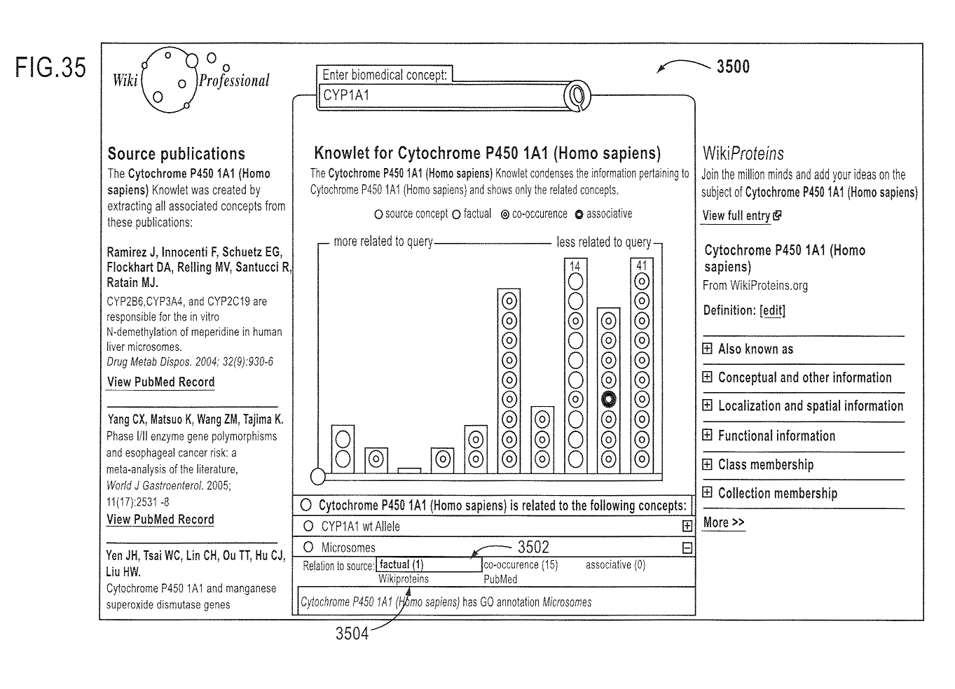

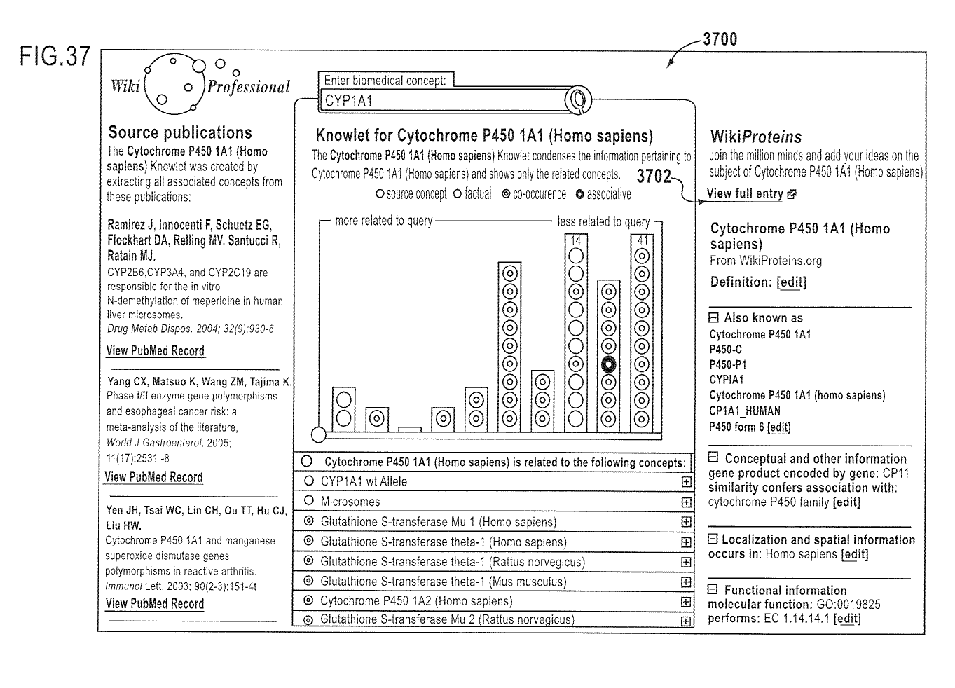

Once user 101 has been directed to the unified results page in step 716, system 100 displays, in step 802, relationships between concepts graphically as shown in box 3202 of FIG. 32 or textually as shown in box 3502 of FIG. 35. System 100 also displays concepts related to the queried concept in step 804. These related concepts are displayed in box 3204 of FIG. 32. Next, system 100 links the page with wiki pages for the related concepts in step 806 (shown as link 3504 in FIG. 35). System 100 displays, in step 810, the source publications used to create the concept space or Knowlet. The publications are shown listed as 3402-3408 in FIG. 34. System 100 creates a link to the publications by way of exemplary links 3410-3414. System 100 then enables a link to the full wiki page on the concept in step 816. The link 3702 is shown in FIG. 37. Process 800 then terminates as indicated by step 820.

Referring now to FIG. 9, a flowchart depicting an exemplary GUI implementation of the dictionary lookup page process 900 according to an aspect of the present invention is shown. In conjunction with process 900, reference is also made to FIG. 31, which shows exemplary Web pages depicting, inter alia, the GUI implementation of process 900 and different aspects of an exemplary dictionary lookup page according to an aspect of the present invention.

System 100 enables user 101 to enter a concept in step 902. This is done by generating search box 3102 shown in FIG. 31. System 100 then searches, in step 904, a thesaurus or ontological database entered by user 101. The results of the search, in step 906, are then displayed as results 3106-3114 on the screen as shown in box 3104 of FIG. 31. They are enabled in step 908 for selection by a user. In addition, in step 910, results 3106-3114 are configured as links to additional data regarding each result. Process 900 then terminates as indicated by step 912.

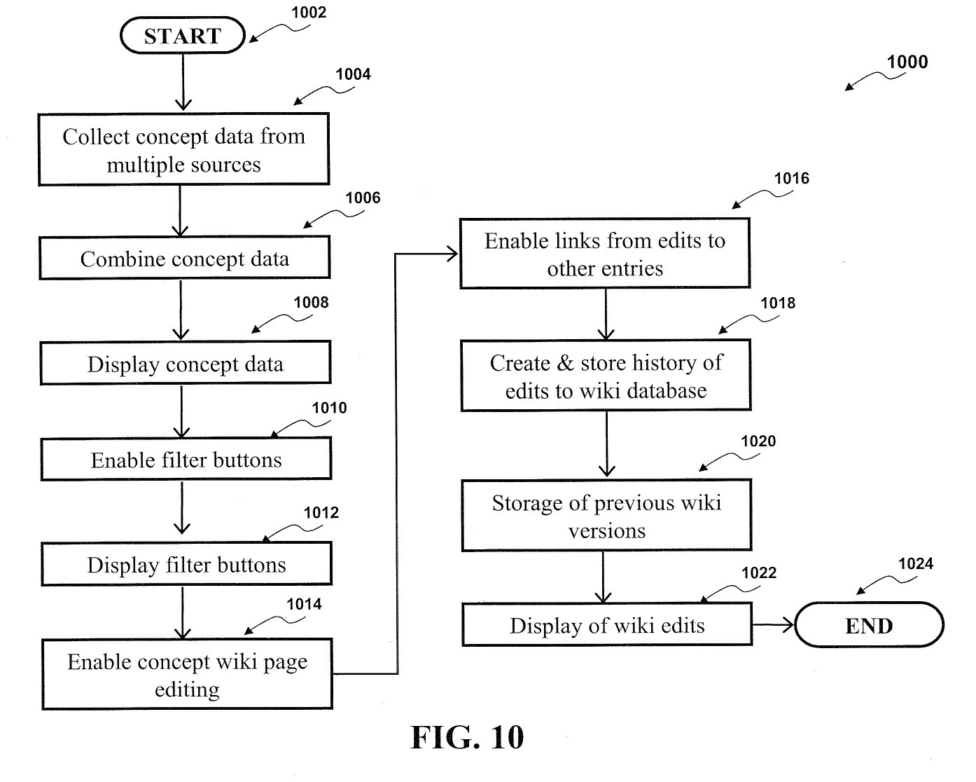

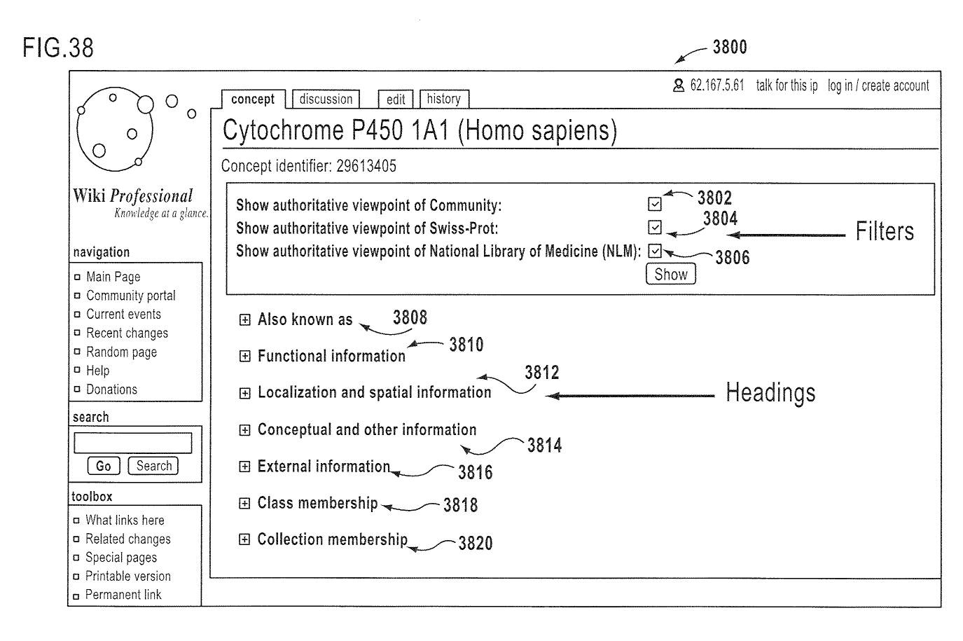

Referring now to FIG. 10, a flowchart depicting an exemplary concept aggregation and collection process 1000 according to an aspect of the present invention is shown. In conjunction with process 1000, reference is also made to FIGS. 38-41 and FIG. 45A, which depict, inter alia, the GUI implementation of process 1000 and exemplary concept pages in a relational Wiki database according to an aspect of the present invention.

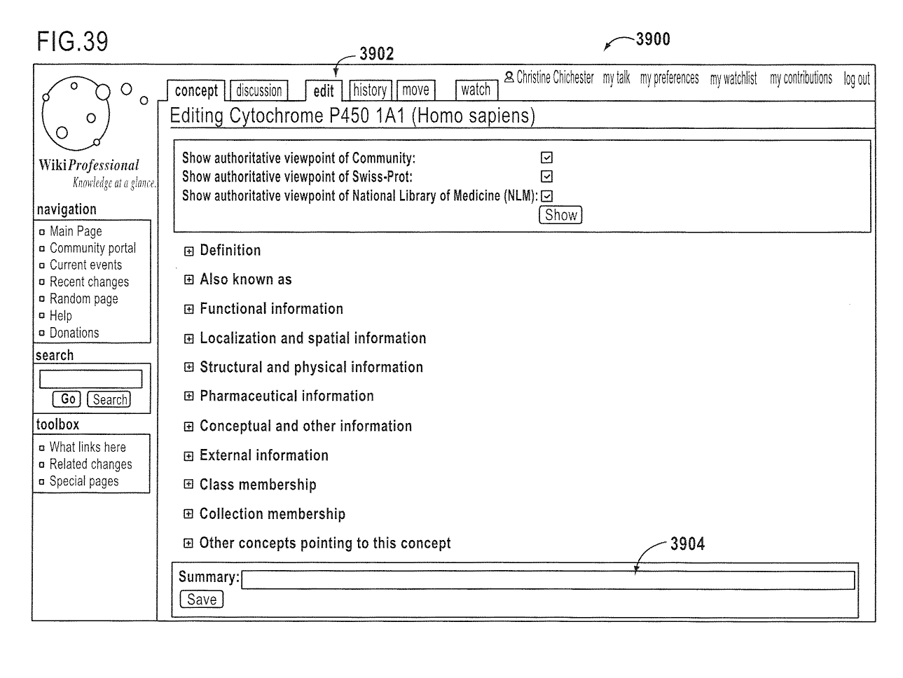

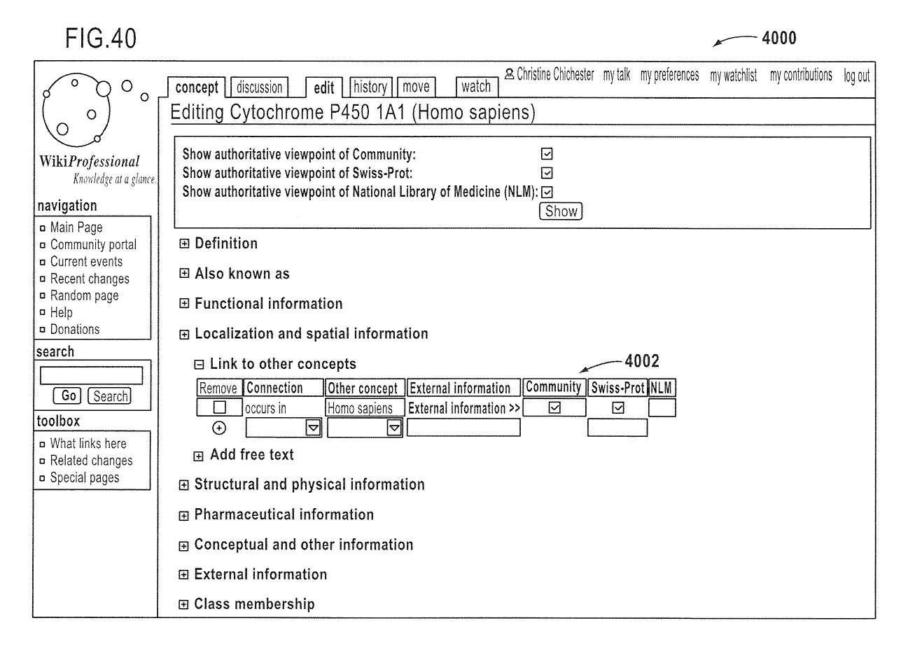

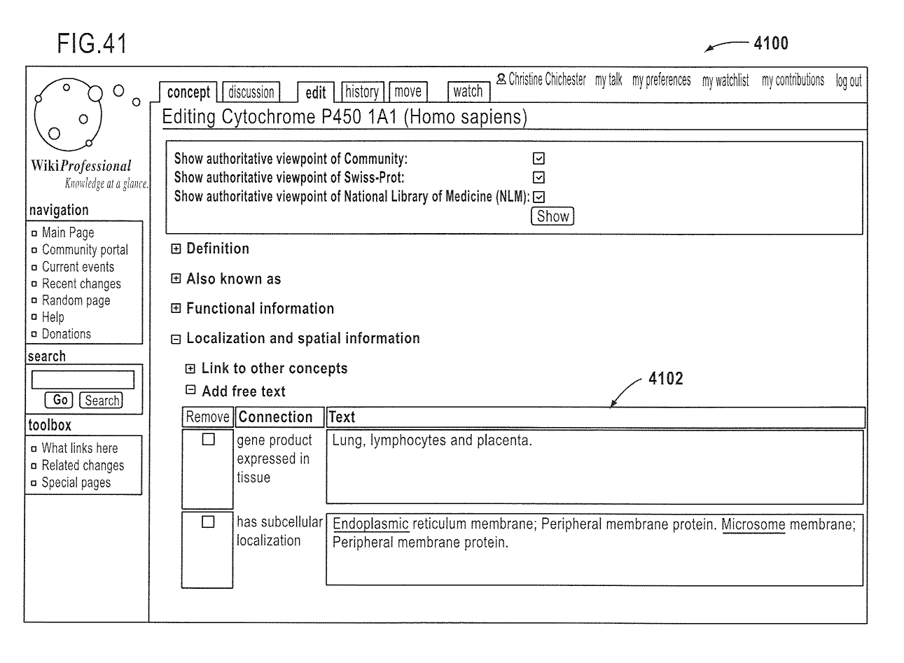

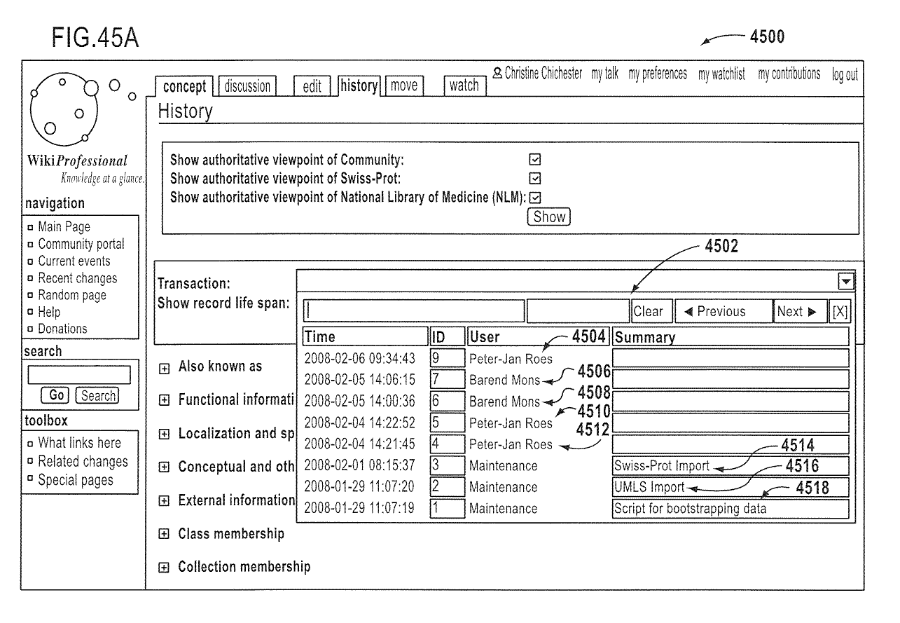

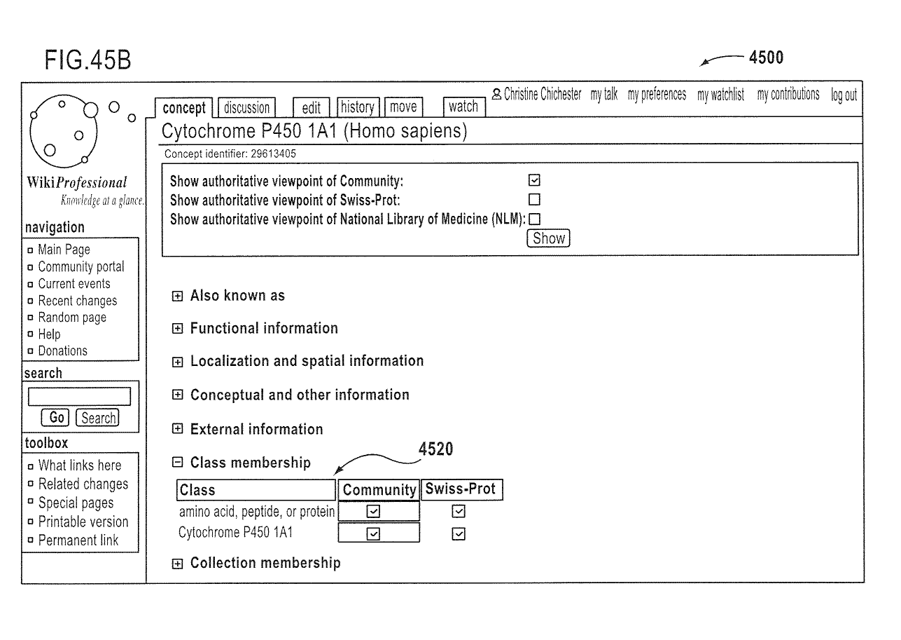

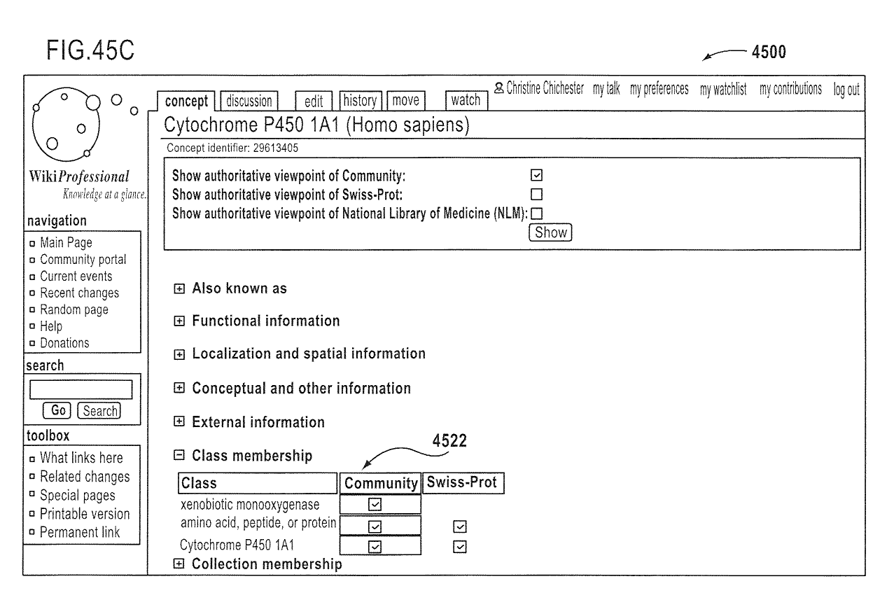

Process 1000 begins at step 1002 with control passing immediately to step 1004. System 100 collects concept data from multiple sources, in step 1004, and combines the collected data in step 1006. The data may be displayed or have links to them displayed in step 1008. System 100 enables and displays filter buttons in steps 1010 and 1012 for the combined concept data which enables user 101 to selectively review the data. Filter buttons are shown as checkboxes 3802-3806 in FIG. 38. In step 1014, system 100 also enables the editing of the wiki page containing the combined data as shown by buttons 3902 and textual input box 3904 in FIG. 39. Alternatively, an editing facility 4002 as shown in FIG. 40 may be provided for concept linking edits to the wiki page in step 1016. User 101 is also able to add text by using an editing drop-down box 4102 as shown in FIG. 41. User 101 may then add any text into the boxes while also having the ability to remove any unwanted text from the page through this editing facility. Later, system 100 stores all edits, edit history and previous wiki versions in steps 1018 and 1020 This historical database may be displayed, in step 1022, as shown in FIG. 45A. History box 4502 shows edits 4504-4518 in terms of the identities of the users performing the edits, a summary of the edits, and the time of the edits.

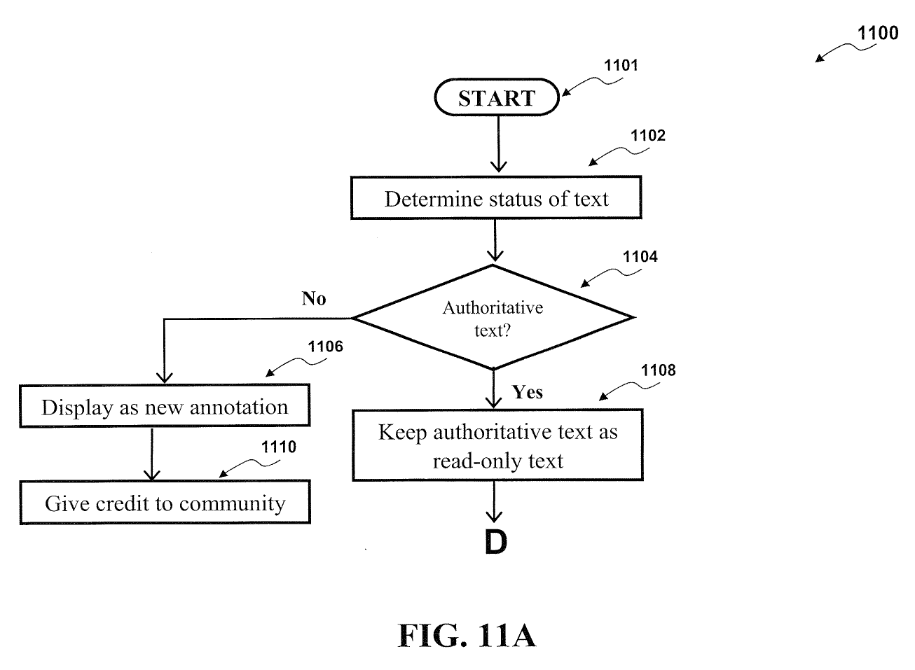

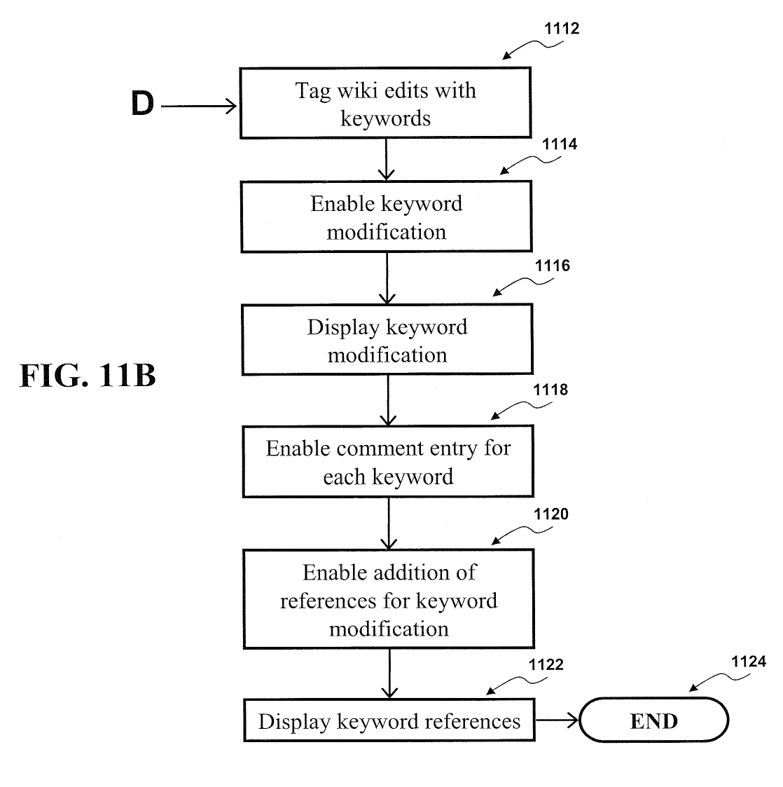

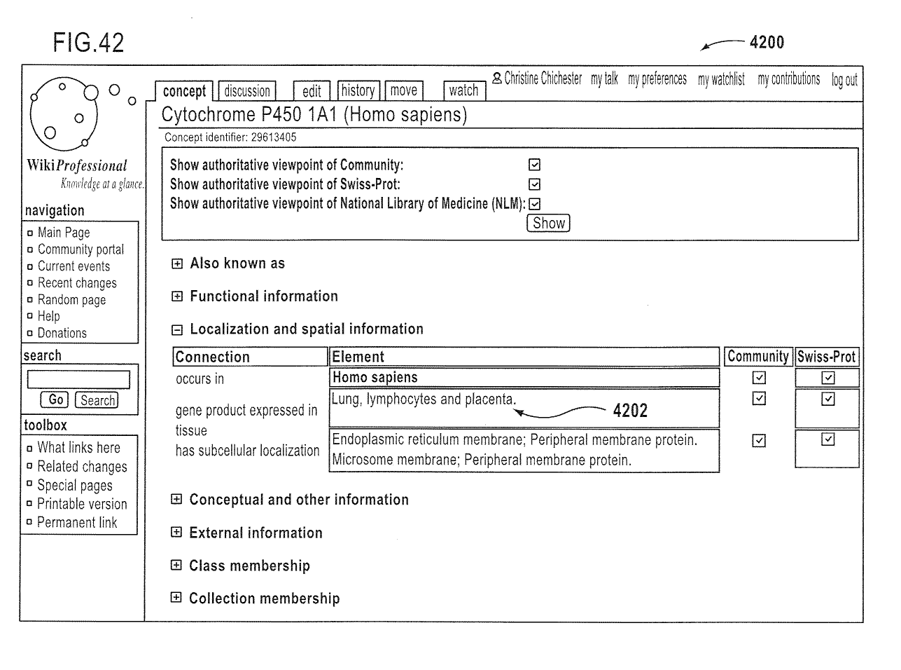

Referring now to FIG. 11A-11B, a flowchart depicting an exemplary process 1100 of text entries, tags and edits according to an aspect of the present invention is shown. In conjunction with process 1100, reference is also made to FIGS. 42-43 and FIGS. 45A-C-46, which depict, inter alia, the GUI implementation of process 1100 and exemplary concept pages in a relational Wiki database according to an aspect of the present invention.

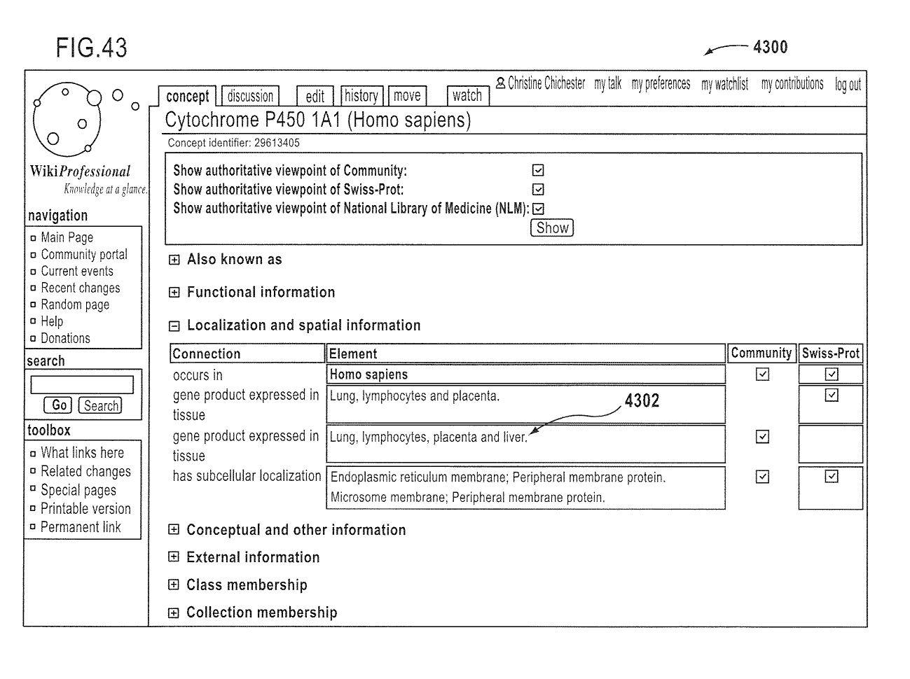

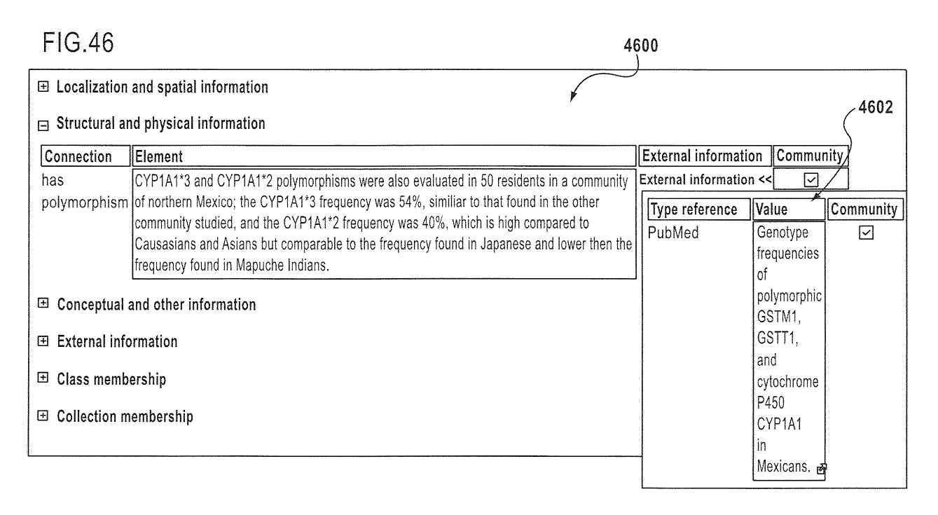

Process 1100 begins at step 1101 with control passing immediately to step 1102. Following the collection and combination of concept data, system 100 determines the status of text to determine whether the text is from an authoritative source in steps 1102 and 1104. Where the text is from an authoritative source, the text is displayed as read-only and cannot be edited (shown as text boxes 4202 and 4302 in FIGS. 42-43). New text is displayed as a new annotation and user 100 is able to provide credit on the page in step 1110 to the source of the new annotation. Each new annotation is then tagged with keywords associated with the annotation in step 1112 with the keywords shown in box 4520 of FIG. 45B. The keywords may be modified in steps 1114 and 1116 by user 101 to better reflect the community viewpoint of the keyword. The modification may take the form of the drop-down box 4522 as shown in FIG. 45C. User 101 may also be able to add the references for the keyword modification in step 1120 and as shown in FIG. 46. The keywords are then displayed in step 1122 as shown in box 4602 of FIG. 46.

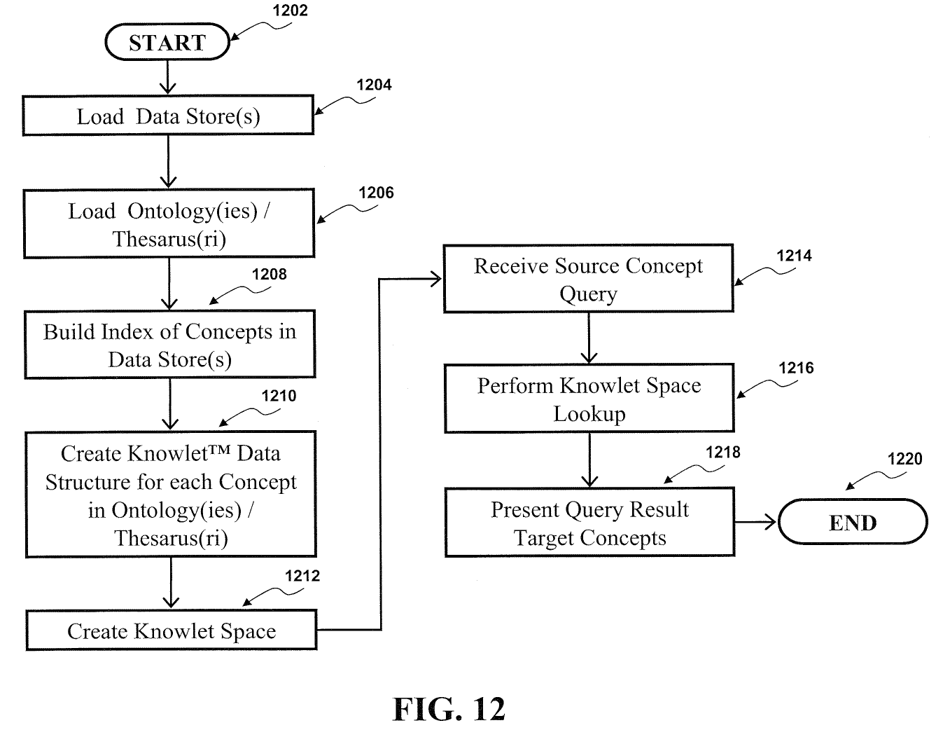

Referring to FIG. 12, a flowchart depicting an exemplary Knowlet space creation and navigation process 1200 of the automated tool according to an aspect of the present invention is shown. Process 1200 begins at step 1202 with control passing immediately to step 1204.

In such an aspect of the present invention, system 100 in step 1204 connects to one or more data stores (e.g., PubMed) containing the knowledge base in which the user seeks to navigate, search and discover.

In such an aspect of the present invention, step 1206 connects the system to one or more ontologies or thesauri relevant to the data store(s). Thus, where the data store is one of biomedical abstracts, for example, the ontology may be one or more of the following ontologies, among others: the UMLS (as of 2006, the UMLS contained well over 1,300,000 concepts); the UniProtKB/Swiss-Prot Protein Knowledgebase, an annotated protein sequence database established in 1986; the IntAct, a freely available, open source database system for protein interaction data derived from literature curation or direct user submissions; the Gene Ontology (GO) Database, an ontology of gene products described in terms of their associated biological processes, cellular components and molecular functions in a species-independent manner; and the like.

As will be appreciated by those skilled in the relevant art(s) after reading the description herein, aspects of the present invention are language-independent, and each concept may be given a unique numerical identifier and synonyms (whether in the same natural language, jargon or in different languages) of that concept would be given the same numerical identifier. This helps the user navigate, search and perform discovery activities in a non-language specific (or dependent) manner.

In such an aspect of the present invention, step 1208 goes through each record of the data store (e.g., go through each abstract of the PubMed database), tags the concepts from the ontology (e.g., ULMS) that appear in each record, and builds an index recording the locations where each concept is found in each record (e.g., each abstract in PubMed). In one aspect, the index built in step 1208 is accomplished by utilizing an indexer (sometimes referred to as a “tagger”) which are known in the relevant art(s). In such an aspect, the indexer is a named entity recognition (NER) indexer (which utilizes the one or more ontologies or thesauri relevant to the data store(s) loaded in step 1206) such as the Peregrine indexer developed by the Biosemantics Group, Medical Informatics Department, Erasmus University Medical Center, Rotterdam, The Netherlands; and described in Schuemie M., Jelier R., Kors J., “Peregrine: Lightweight Gene Name Normalization by Dictionary Lookup” Proceedings of Biocreative 2, which is hereby incorporated by reference in its entirety. Examples of other NER indexers include: the ClearForest Tagging Engine available from Rueters/ClearForest of Waltham, Mass.; the GENIA Tagger available from the Department of Information Science, Faculty of Science, University of Tokyo; the iHOP service available on the World Wide Web; IPA available from Ingenutity Systems of Redwood City, Calif.; Insight Discoverer™ Extractor available from Temis S.A. of Paris, France; and the like.

In one aspect of the present invention, step 1210 creates a Knowlet for each concept in the ontology which “records” the relationship between that concept and all other concepts (as well as semantic distances/associations) within the concept space. In such an aspect, a search engine, such as the Lucene Search Engine, may be used to search the data store(s) for the occurrences of the concepts loaded into the system in step 1206 and to determine the relationships between the concepts using the index created in step 1208. The Lucene Search Engine, used in this example, is available under the Apache Software Foundation License and is a high-performance, full-featured text search engine library written in Java suitable for nearly any application that requires full-text (especially cross-platform) search.

In such an aspect of the present invention, step 1212 creates and stores within the system (e.g., storing within a data store associated with server 106) a “Knowlet space” (or concept space), which is a collection of all the Knowlets created in step 1210, thus forming a larger, dynamic ontology. Thus, if the ontology contains N concepts, the Knowlet space may be (at most) a [N]×[N−1]×[3] matrix detailing how each of N concepts relates to all other N−1 concepts in a Factual (F), Co-occurrence and (C) Associative (A) manner. In such an aspect of the present invention, step 1212 includes the steps of calculating the F, C and A attributes (or values) for each concept pair. Thus, the Knowlet space is a virtual concept space based on all Knowlets, where each concept is the source concept for its own Knowlet and a target concept for all other Knowlets. (When the F, C or A values are non-zero within a Knowlet for a particular source/target concept combination, this is denoted herein as being in a F+, C+or A+ state, respectively. And, when the values are less than or equal to zero, they are denoted as F−, C− or A−, respectively.)

As will be appreciated by those skilled in the relevant arts after reading the description herein, in the aspect of the present invention where the ontology is the UMLS, N may be well over 1,000,000 in magnitude.

As noted above, however, one aspect of the present invention contemplates the use of any number of attributes. Thus, in such an aspect, the Knowlet space may be represented as an [N]×[N−1]×[Z] matrix detailing how each of N concepts relates to all other N−1 concepts with respect to each of Z attributes. In such an aspect of the present invention, step 1212 would include the steps of calculating Z number of attributes (or values) for each concept pair.

As will be appreciated by those skilled in the relevant arts after reading the description herein, in the aspect of the present invention, the Knowlet space may be made smaller (and thus optimized for computer memory storage and processing) than a [N]×[N−1]×[Z] matrix by reducing the [N−1] portion of the Knowlet. This is accomplished by a scheme where each concept is the source concept for its own Knowlet, and only those subset of N−1 target concepts where any of the Z attribute values (e.g., the F, C and A values) are positive are included as target concepts in the source concept's Knowlet.

In the aspect of the present invention where step 1212 includes the steps of calculating the F, C and A attributes (or values) for each concept pair, the F value may be determined, for example, by factual relationships between two concepts as determined by analyzing the data store. In one aspect of the present invention, <noun><verb><noun> (or <concept><relation><concept>) triplets are examined to deduce factual relationships (e.g., “malaria”, “transmitted” and “mosquitoes”). Thus the F value may be, for example, either zero (no factual relationship) or one (there is a factual relationship), depending on the search of the one or more data stores loaded in step 1204.

Although the factual F value is zero or one, in one aspect of the present invention, it will be recognized by those of ordinary skill in the art that the factual attribute F may be influenced by taking into account one or more weighting factors, such as the semantic type(s) of the concepts, for example, as defined in the thesaurus. For example, a more meaningful relationship is presented by <gene> and <disease>, than by <gene> and <pencil>, which may in turn influence the F value. In this example, the F value is determined by the existence (or non-existence) of factual relationships in authoritative data sources accepted by the scientific community in a given area, such as PubMed. However, it will be apparent to those of ordinary skill in the art that the F value is not an indication of the veracity or authenticity of the concept or relationship, and that it may be determined based on other factors. Further, repetition of facts is of great value for the readability of individual text (e.g., articles) in the data store, but the fact itself is a single unit of information, and needs no repetition within the Knowlet space. There is an intuitive relationship between the level of repetition of facts in the “raw literature” of the data store and the likelihood that the fact is “true,” but even multiple repetitions do not guarantee that a fact is really true. Thus, in an aspect of the present invention, it is assumed that beyond a predefined threshold, further repetition of a fact does not increase the likelihood that the factual statement is true.

The C value is determined by the co-occurrence relationship between two concepts, determined by whether they appear within the same textual grouping (e.g., per sentence, per paragraph, or per x number of words). In one aspect of the present invention, the C value may range from zero to 0.5 based on the number of times a co-concurrence of the two concepts is found within the data store(s). A co-occurrence may be determined by taking into account one or more weighting factors, such as the semantic type(s) of the concepts in the data store. The C value may therefore be influenced by, for example, one or more weights. That is, if a <drug> and a <disease> both occur in the same textual grouping under consideration (e.g., a sentence), there is in fact a co-occurrence. If <drug> and <city>, however, both occur in the same sentence, a co-occurrence relationship is less likely indicated by the present invention, in accordance with one aspect.

The A value is determined by the associative relationship between two concepts. In one example, the A value may range from zero to 0.4 depending on the outcome of a multidimensional scaling process in a cluster of concepts (i.e., n-dimensional space), which explores similarities or dissimilarities in the data store between the two concepts. The A value is an indication of conceptual overlap between two concepts. In one example, the closer the two concepts are in the multidimensional cluster of concepts, the higher the associative value A between them will be. If there is little or no conceptual overlap, the associative value A will be closer to zero.

The indirect association between two concepts is calculated based upon the matching of their individual “concept profiles.” A concept profile is constructed as follows: For each concept found in the data store(s) loaded into system 100, a number of records are retrieved in which that specific concept has a significant incidence. In certain aspects, high precision may be favored at the expense of (IR) recall. A list is thus constructed such that concepts from minimally one, but up to a pre-defined threshold (e.g., 250), selected records within the data store (e.g., abstracts in PubMed) that are “about” that source concept. A ranked concept lists is then constructed by terminology-based, concept-indexing of the entire returned record (e.g., a PubMed abstract), followed by weighted aggregation into one list of concepts. The concepts in this list exhibit a high association with the source concept. These lists can now be expressed as vectors in multidimensional space and the associative score (A), for each of the vector pairs, is calculated. This associative score is recorded as a value between 0 and 1 in the A category of the Knowlet. Thus, even for those concepts between which the F and C parameters are negative, a positive association score A beyond a statistically defined threshold may indicate that there is significant conceptual overlap in their respective concept profiles to suggest an as yet non-explicit relationship. Thresholds can be calculated by comparing the distribution concept profile matches of non-related concepts of certain semantic types with those that are known to interact (e.g., all proteins that are not known to interact with those that are known to interact in Swiss-Prot and IntAct).

In an aspect of the present invention, in the case where neither F nor C is positive for a given pair of concepts, there may still be circumstantial evidence for a meaningful relationship between the concepts, even if the association is only implicit. Such associative connections are captured in the Knowlet as the third parameter, A. In one aspect of the invention, the A parameter represents the most interesting aspect of the Knowlet (e.g., while using system 100 in a “discovery” mode as detailed below). As facts are moved from a C+ and F− state to an F+ state, the data store(s) loaded into system 100 become more factually solidified. However, bringing a concept combination from a F−, C− and A+ state to an F+ state will either yield new co-occurrences and facts missed so far or, more importantly, may in fact be part of the knowledge discovery process by in silico reasoning (and potentially, later laboratory-related experiments to confirm literature based hypotheses).

As will be appreciated by those skilled in the relevant art(s) after reading the description herein, steps 1204-1212 may be periodically repeated so as to capture updates to the data store(s) (e.g., new abstracts in PubMed) and/or ontology(ies) (i.e., new concepts).

In one aspect of the present invention, step 1214 receives a search query from a user consisting of one or more source concepts (i.e., a selected concept taken as the starting point for knowledge navigation and discovery within the concept space).

In one aspect of the present invention, step 1216 performs a lookup in the Knowlet space and calculates a semantic distance (SD) for all N−1 potential target concepts relative to the source concept, and produces a set of target concepts (i.e., concepts in the concept space that have a relation to the source concept). In one aspect, for example, the system would return a set of target concepts corresponding to the 50 highest SD values calculated within the Knowlet space.

In such an aspect, the semantic distance may be calculated:

SD=w₁F+w₂C+w₃A;

where w₁, w₂ and w₃ are weights assigned to the F, C and A values, respectively. As will be appreciated by those skilled in the relevant art(s) after reading the description herein, users may be able to query the system in different modes which would then automatically adjust the w₁, w₂ and w₃ values. For example, in a “background” mode where the user simply wants factual, background information, w₁, w₂ and w₃ may be set to 1.0, 0.0 and 0.0, respectively. In another example, in a “discovery” mode where the user simply wants to highlight associative relationships, w₁, w₂ and w₃ may be set to 1.0, 0.5 and 2.0, respectively. In other aspects of the present invention, the F, C and A values may be weighted by different factors or characteristics (e.g., by semantic type) in different modes. Thus, the SD (or semantic association) is the computed semantic relationship between a source concept and a target concept based on weighted factual, co-occurrence and associative information.

In one aspect of the present invention, step 1218 presents the target concepts to the user via GUI such that the user may view the source concept, the set of target concepts (color coded according to F, C, A and/or SD values) and the list of records within the data store(s) (i.e., the PubMed abstracts) which form the basis of the relationships for the SD calculations. Process 1200 then terminates as indicated by step 1220.

In another aspect of the present invention, the user may enter two or more source concepts. In such an aspect, the system produces a set of target concepts which relate to all of the source concepts entered. As will be appreciated by those skilled in the relevant art(s) after reading the description herein, such an aspect may serve as a better IR or search engine. That is, source concepts A and B may have no factual (F) or co-occurrence (C) relationships in the one or more data store(s) loaded into the system in step 1204. Thus, a traditional search engine may yield no results while performing a traditional Boolean/keyword search. Utilizing the Knowlet space, however, the present invention is able to produce target concepts which associatively (A) link the source concepts A and B.

In another aspect of the present invention, steps 1208 and 1210 described above can be augmented by also indexing the authors of the records in the data store (i.e., the authors of the publications whose abstracts appear in PubMed). In such an aspect of the present invention, not only are the N concepts mapped to each other in the Knowlet space, but also the universe of M authors are uniquely mapped to the N concepts such that the Knowlet space is now a [N+M]×[N+M−1]×3 matrix (i.e., a concept space where each concept has a Knowlet and each author has a Knowlet). As will be appreciated by those skilled in the relevant art(s) after reading the description herein, such an aspect would allow users to easily identify experts related to particular concepts for collaborative research purposes.

As will be appreciated by those skilled in the relevant art(s) after reading the description herein, in aspects of the present invention where the universe of M authors are uniquely mapped to the N concepts such that the Knowlet space is a [N+M]×[N+M−1]×3 matrix (provided the number of Z attributes is three), many useful tools can be presented to users of system 100. In one such aspect, various contribution factors may be calculated for each of the M authors who appear in the data store(s) loaded into the system in step 1204. The contribution factors would distinguish between those authors who were simply prolific (i.e., had a large number of publications) and those who were “innovative” (i.e., those authors whose works were responsible for two concepts co-occurring for the first time within the Knowlet space). As will be appreciated by those skilled in the relevant art(s) after reading the description herein, contribution factors may be calculated in a number of ways given the Knowlet space and the F, C and A parameters stored therein (e.g., the contribution factor may be based upon a per sentence, per article, or other basis). Contribution factors may also be calculated based on a sentence, sentences, an abstract or document, or a publication in general.

In another aspect of the present invention, as will be appreciated by those skilled in the relevant art(s) after reading the description herein, any images found within the data store(s) loaded into the system in step 1204 (e.g., images found within articles in the data store) or images found in any other repository of images, may be associated with any of the N concepts during step 1208. These images would then be indexed and referenced within the Knowlet space and utilized as another data point (or field) upon which the tool to navigate, search and perform discovery activities described herein may operate.

In another aspect of the present invention, as will be appreciated by those skilled in the relevant art(s) after reading the description herein, two separate Knowlet (or concept) spaces resulting from parallel set of steps 1204-1212 described above may be compared and searched to aid in the knowledge navigation and discovery process. That is, a Knowlet space created using a database and ontology from a first field of study may be compared to a second Knowlet space created using a database and ontology from a second (e.g., related) field of study. In one aspect, if a query in one ontology or resource fails to yield results, the present invention may provide an indication, based on the Knowlet space, that one or more relevant results may be found in the Knowlet space derived from another ontology or thesaurus.

In other aspects of the present invention, the tool to navigate, search and perform discovery activities may be provided in an enterprise fashion for use by an authorized set of users (e.g., research scientists within the R&D department of a for-profit entity, research scientists within a university, and the like). In such an aspect, the one or more (public) data stores loaded into the system can be augmented by one or more proprietary data stores (e.g., internal, unpublished R&D) and/or the one or more (public) ontologies or thesauri loaded into the system can be augmented by one or more proprietary ontologies or thesauri. In such an aspect, the combination of public and private data allows for a more complete (and, if desired, proprietary) concept space and thus more knowledge navigation and discovery capabilities. In such an aspect, the one or more private data stores loaded into the system may be unpublished articles by authors within the enterprise. This would allow users within the enterprise, for example, to capture and recognize, for example, new co-occurrences within the Knowlet space before the publication goes to print.

In other aspects of the present invention, the tool to navigate, search and perform discovery activities may offer users one or more security options. For example, in one aspect of the present invention, a Knowlet space created through the use of one or more proprietary data stores (e.g., internal, unpublished R&D) and/or one or more proprietary ontologies or thesauri may be stored within system 100 in an encrypted manner during step 1212. In such an aspect of the present invention, as will be appreciated by those skilled in the relevant art(s), an encryption process may be applied to the Knowlet space such that only those with a decoding key (i.e., authorized users) may decrypt the Knowlet space.

In another aspect of the present invention, the tool for navigating, searching and performing knowledge discoveries may be used to select and/or categorize the output of Internet search engines “on the fly.” For example, the output of the search engine may be sorted and categorized, by URL, into folders in a data repository, for example, within the plug-in itself. On the basis of the documents stored in such folders and/or on the basis of concepts that have been accepted as text, the present invention, in one aspect, may create a user's interest profile.

As mentioned above, step 1218 presents the target concepts to the user via a GUI such that the user may view the source concept, a wiki containing the definition of the source concept, and the set of target concepts. Thus, in aspects of the present invention, the user may edit the definition of the source concept in one or more of the displayed wikis (based on their observations of the target concepts and the list of records within the data store(s) which form the basis of the relationships for the SD calculations).

In another aspect of the present invention, where the tool to navigate, search and perform knowledge discovery is provided as an Internet browser plug-in or add-on, a button on a tool bar or pull-down menu may be provided to serve as a “newness indicator.” That is, as a user browses the Internet and comes across a Web page of interest, the user may click a “newness” button on a tool bar or pull-down menu provided by the present invention which would then parse through the HTML code of the active Web page “on the fly” and grey-out (e.g., show in grey) all the concepts found in the user's personal Knowlet space. In such an aspect, the user's attention would be directed to the text on the Web page which actually represents “new” knowledge with respect to the user (i.e., knowledge gained from documents already read by the user would appear in grey or any other desired color, which would be in contrast to the remaining text, the color or other attributes of which would not be modified).

In another aspect of the present invention, the tool to navigate, search and perform discovery activities may be provided via a proxy server such that a user's “favorite” or “bookmarked” Web sites are pre-parsed. In such an aspect, the user's browser would highlight (e.g., show in yellow) all the concepts found in the one or more ontologies or thesauri loaded in step 1206 above without any manual intervention (i.e., without having to activate a “wikifier” button or menu option).

In other aspects of the present invention, the tool to navigate, search and perform knowledge discovery may be provided as a word processing/text editing plug-in or add-on. That is, as a user edits a wiki displayed along with the target concepts (as described above) or authors a new paper, the one or more ontologies or thesauri relevant the Knowlet space loaded into the system in step 1206 above may be periodically consulted. Such a plug-in or add-on would recognize any of the N concepts as they are being typed by the user, and then make “on the fly” suggestions as to as synonyms, homonyms, translations and/or connected concepts thus functioning as a “Do you mean [list of n suggested concepts]?” tool. Further, the plug-in or add-on may allow displaying and/or changing the status of a concept in real time. For example, an indication may be provided regarding, among other factors, whether a concept of interest is appropriately defined and whether it is translated in one or more languages, thus providing an on-line “on the fly” concept status report.

### The Concept Web

In the relevant arts, “Web 1.0” refers to the state of the World Wide Web between approximately 1994 and 2004. Such state was a “read-only” state where most sites were one-way, published media (i.e., text and pictures). The term “Web 2.0” was coined circa 2004 (and which has very loosely defined boundaries) to refer to the evolution of the Web to a “read-and-write” state. That is, Web 2.0 reflects the Web-based communities and hosted services such as social-networking sites, wikis, blogs, and folksonomies, which aim to facilitate creativity, collaboration and sharing among users.

Now, aspects of the present invention facilitate a “semantic Web” (i.e., a Web 3.0 state) where a dynamic, interactive Web of concepts (or “Concept Web”) and their relationships derived from the World Wide Web and off-line resources, where both redundancy and ambiguity have been removed.

The first premise for the Concept Web is that a user/researcher performing an Internet search is not interested in data and information per se, but in a synthesis of these “building blocks” into executable knowledge upon which they can act. This premise holds, for example, when the user is looking for the “best hotel in Amsterdam,” all the way through to a highly complicated biological pathway. Such user is not interested in all information about all hotels in Amsterdam, nor can they read all 5000 scientific papers referring to all 50 genes in a hypothetical pathway. Instead, the user is really interested in making a decision where to stay in Amsterdam or which gene to postulate as causing a given disorder. The Concept Web, according to aspects of the present invention, enables just that desired outcome while reducing the interim need for reading and analyzing to a bare minimum, and without losing crucial information and trust.

Barriers to the Concept Web, however, include the problems of ambiguity and size. The “ambiguity problem” with respect to pages of text on the Internet (or any other data store) refers to the property of words, terms, notations, signs, symbols and concepts within a particular context as being undefined, indefinable, multi-defined or without an obvious definition, and thus having a misleading, or unclear, meaning. The “size problem” with respect to pages of text on the Internet (or any other data store) refers to the fact that most recent (2007) estimates of Web pages on the Internet are at 500 billion Web pages, spread over more than 100 million Web sites.

As will be appreciated by those skilled in the relevant art(s) after reading the description herein, the current state of the art is such that even highly ambiguous terms and tokens such as gene symbols with many meanings can be resolved by advanced disambiguation algorithms with a typical 80% precision at 80% recall. Therefore, aspects of the present invention may further include emerging disambiguation techniques to optimally reduce ambiguity.

As will be appreciated by those skilled in the relevant art(s) after reading the description herein, the “size problem” with respect to pages of text on the Internet (or any other data store) is created in part by redundancy. Taking scientific literature as representative of general published materials, the vast majority of sentences contain factual statements that have been stated minimally once before. In many cases, general facts are endlessly repeated to serve the readability of individual papers.

For example, it has been know for over a century that “Malaria” is “transmitted” by “Mosquitoes.” The PubMed bibliographic database (with over 17,000,000 abstracts), for example, contains 5618 instances of this co-occurrence. The added value of the over 5000 repetitions after the first ever statement is in the reconfirmation (and gradual solidification) of the stated fact and in the increase of the readability of the articles about malaria and its transmission and the dispersion of this fact in conjunction with other facts in individual documents. Utilizing Knowlets, in one aspect of the present invention, multiple attributes and values for relationships between concepts are combined such that scientific texts containing many reiterations of factual statements result in the relationships between two concepts being recorded only once. The attributes and values of the relationships change based on multiple instances of factual statements, increasing co-occurrence or associations. This approach results in a minimal growth of the Concept Web space as compared to the text space. Thus, in aspects of the present invention, a “zipping of the Web” (i.e., a compression) can be achieved.

As mentioned previously, two separate Knowlet (or concept) spaces resulting from parallel sets of steps 1204-1212 described above may be compared and searched to aid in the knowledge navigation and discovery process. That is, a Knowlet space created using a database and ontology from a first field of study may be compared to a second Knowlet space created using a database and ontology from a second field of study. Similarly, aspects of the present invention described above which result in a “zipping of the Web”, may be utilized to compare two or more zipped datasets at the concept level.

### Example Implementation

Aspects of the present invention, the methodologies described herein or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

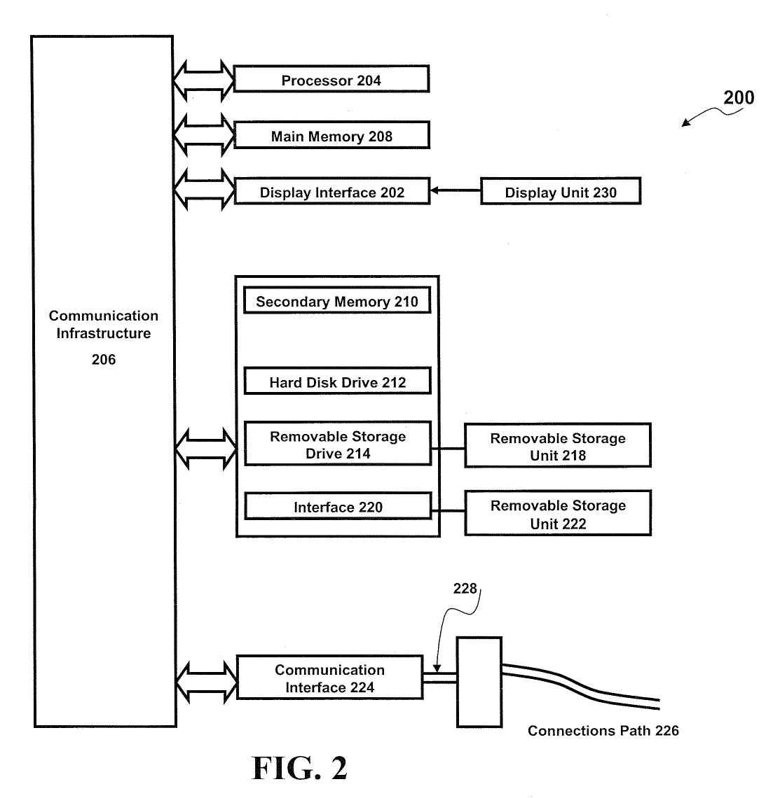

In fact, in one aspect, the invention is directed toward one or more computer systems capable of carrying out the functionality described herein. An example of a computer system 200 is shown in FIG. 2.

The computer system 200 includes one or more processors, such as processor 204. The processor 204 is connected to a communication infrastructure 206 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230.

Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218 represents a floppy disk, magnetic tape, optical disk, etc. which is read by and written to by removable storage drive 214. As will be appreciated, the removable storage unit 218 includes a computer usable storage medium having stored therein computer software and/or data.

In alternative aspects, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228 which may be electronic, electromagnetic, optical or other signals capable of being received by communications interface 224. These signals 228 are provided to communications interface 224 via a communications path (e.g., channel) 226. This channel 226 carries signals 228 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 214, a hard disk installed in hard disk drive 212, and signals 228. These computer program products provide software to computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an aspect where the invention is implemented using software, the software may be stored in a computer program product and loaded into computer system 200 using removable storage drive 214, hard drive 212 or communications interface 224. The control logic (software), when executed by the processor 204, causes the processor 204 to perform the functions of the invention as described herein.

In another aspect, the invention is implemented primarily in hardware using, for example, hardware components such as application specific integrated circuits (ASICs). Implementation of the hardware state machine so as to perform the functions described herein will be apparent to persons skilled in the relevant art(s).

In yet another aspect, the invention is implemented using a combination of both hardware and software.

### Conclusion

While various aspects of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary aspects.

In addition, it should be understood that the figures and GUI screens illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. A method for facilitating and displaying knowledge navigation and discovery utilizing a graphical user interface, comprising:
launching a proxy Web site;
selecting a target Web site;
passing said target Web site through said proxy Web site;
enabling search parameters;
entering a search concept; and
highlighting said search concept as it appears on said target Web site.

2. The method of claim 1, further comprising displaying buttons for said search parameters.

3. The method of claim 1, further comprising:
reviewing concepts of said target Web site;
highlighting unrecognized concepts;
creating a link to said unrecognized concepts;
creating a wiki page for said unrecognized concepts; and
adding said unrecognized concepts to a concept database.

4. The method of claim 3, further comprising:
highlighting said unrecognized concepts based on selected search parameters; and
categorizing said unrecognized concepts.

5. The method of claim 1, further comprising:
generating a pop-up screen; and
populating said pop-up screen with concept data.

6. The method of claim 5, further comprising linking said pop-up screen with a concept database.

7. The method of claim 1, further comprising:
enabling refined search functionality; and
displaying buttons for said refined search functionality.

8. A method for facilitating and displaying knowledge navigation and discovery utilizing a graphical user interface, comprising:
creating a concept database;
identifying relationships between concepts;
storing information on said identified concept relationships; and
comparing a target concept with concepts in said concept database.

9. The method of claim 8, further comprising generating a unified results page.

10. The method of claim 8, further comprising generating a dictionary lookup page.

11. The method of claim 10, further comprising:
displaying relationships between concepts;
displaying related concepts;
displaying source publications;
linking with said source publications; and
linking with a concept wiki page.

12. The method of claim 11, further comprising enabling editing of said concept wiki page.

13. The method of claim 8, further comprising:
enabling concept entry on a search screen;
searching a database for a concept;
displaying dictionary terms of said concept;
selecting a dictionary term; and
linking with data regarding said dictionary term.

14. A method for facilitating and displaying knowledge navigation and discovery utilizing a graphical user interface comprising:
combining concept data from at least two sources;
creating a concept wiki page;
enabling the editing of said concept wiki page;
creating links between concept wiki page edits;
storing a history log of concept wiki pages; and
storing previous versions of said concept wiki page.

15. The method of claim 14, further comprising:
displaying said concept data; and
displaying concept wiki page edits.

16. The method of claim 14, further comprising:
categorizing each concept wiki page edit;
determining which text on said concept wiki page is authoritative; and
displaying said authoritative text.

17. The method of claim 16, further comprising:
displaying non-authoritative text as a new annotation;
providing credit to the source of said non-authoritative text;
searching for a keyword associated with said concept wiki page edit;
enabling comment entry for said keyword; and
enabling entry of a reference for said keyword.

18. The method of claim 17, further comprising enabling the modification of said keyword.

19. A computer program product comprising a computer usable medium having control logic stored therein for causing a computer to facilitate and display knowledge navigation and discovery utilizing a graphical user interface, said control logic comprising:
first computer readable program code means for causing the computer to launch a proxy Web site;
second computer readable program code means for causing the computer to enable the selection of a target Web site;
third computer readable program code means for causing the computer to pass said target Web site through said proxy Web site;
fourth computer readable program code means for causing the computer to enable search parameters;
fifth computer readable program code means for causing the computer to enable the entry of a search concept; and
sixth computer readable program code means for causing the computer to highlight said search concept as it appears on said target Web site.

20. The computer program product of claim 19, further comprising seventh computer readable program code means for causing the computer to display buttons for said search parameters.

21. The computer program product of claim 19, further comprising:
seventh computer readable program code means for causing the computer to review concepts of said target Web site;
eighth computer readable program code means for causing the computer to highlight unrecognized concepts;
ninth computer readable program code means for causing the computer to create a link to said unrecognized concepts;
tenth computer readable program code means for causing the computer to create a wiki page for said unrecognized concepts; and
eleventh computer readable program code means for causing the computer to add said unrecognized concepts to a concept database.

22. The computer program product of claim 21, further comprising:
twelfth computer readable program code means for causing the computer to highlight said unrecognized concepts based on selected search parameters; and
thirteenth computer readable program code means for causing the computer to categorize said unrecognized concepts.

23. The computer program product of claim 19, further comprising:
seventh computer readable program code means for causing the computer to generate a pop-up screen; and
eighth computer readable program code means for causing the computer to populate said pop-up screen with concept data.

24. The computer program product of claim 23, further comprising ninth computer readable program code means for causing the computer to link said pop-up screen with a concept database.

25. The computer program product of claim 19, further comprising:
seventh computer readable program code means for causing the computer to enable refined search functionality; and
eighth computer readable program code means for causing the computer to display buttons for said refined search functionality.

26. A computer program product comprising a computer usable medium having control logic stored therein for causing a computer to facilitate and display knowledge navigation and discovery utilizing a graphical user interface, said control logic comprising:
first computer readable program code means for causing the computer to create a concept database;
second computer readable program code means for causing the computer to identify relationships between concepts;
third computer readable program code means for causing the computer to store information on said identified concept relationships; and
fourth computer readable program code means for causing the computer to compare a target concept with concepts in said concept database.

27. The computer program product of claim 26, further comprising fifth computer readable program code means for causing the computer to generate a unified results page.

28. The computer program product of claim 26, further comprising fifth computer readable program code means for causing the computer to generate a dictionary lookup page.

29. The computer program product of claim 28, further comprising:
sixth computer readable program code means for causing the computer to display relationships between concepts;
seventh computer readable program code means for causing the computer to display related concepts;
eighth computer readable program code means for causing the computer to display source publications;
ninth computer readable program code means for causing the computer to link with said source publications; and
tenth computer readable program code means for causing the computer to link with a concept wiki page.

30. The computer program product of claim 29, further comprising eleventh computer readable program code means for causing the computer to enable the editing of said concept wiki page.

31. The computer program product of claim 26, further comprising:
fifth computer readable program code means for causing the computer to enable concept entry;
sixth computer readable program code means for causing the computer to search a database for a concept;
seventh computer readable program code means for causing the computer to display dictionary terms of said concept;
eighth computer readable program code means for causing the computer to enable the selection of a dictionary term; and
ninth computer readable program code means for causing the computer to link with data regarding said dictionary term.

32. A computer program product comprising a computer usable medium having control logic stored therein for causing a computer to facilitate and display knowledge navigation and discovery utilizing a graphical user interface, said control logic comprising:
first computer readable program code means for causing the computer to collect concept data from multiple sources;
second computer readable program code means for causing the computer to combine said concept data;
third computer readable program code means for causing the computer to create a concept wiki page;
fourth computer readable program code means for causing the computer to enable the editing of said concept wiki page;
fifth computer readable program code means for causing the computer to create links between concept wiki page edits;
sixth computer readable program code means for causing the computer to store a history log of edits to said concept wiki page; and
seventh computer readable program code means for causing the computer to store previous versions of said concept wiki page.

33. The computer program product of claim 32, further comprising:
eighth computer readable program code means for causing the computer to display said concept data; and
ninth computer readable program code means for causing the computer to display concept wiki page edits.

34. The computer program product of claim 32, further comprising:
eighth computer readable program code means for causing the computer to categorize each concept wiki page edit;
ninth computer readable program code means for causing the computer to determine which text on said concept wiki page is authoritative; and
tenth computer readable program code means for causing the computer to display said authoritative text.

35. The computer program product of claim 34, further comprising:
eleventh computer readable program code means for causing the computer to display non-authoritative text as a new annotation;
twelfth computer readable program code means for causing the computer to provide credit to the source of said non-authoritative text;
thirteenth computer readable program code means for causing the computer to search for a keyword associated with said concept wiki page edit;
fourteenth computer readable program code means for causing the computer to enable comment entry for said keyword; and
fifteenth computer readable program code means for causing the computer to enable entry of a reference for said keyword.

36. The computer program product of claim 35, further comprising sixteenth computer readable program code means for causing the computer to enable the modification of said keyword.
